(19) United States
(12) Patent Application Publication
(10) Pub. No.: US 2026/0287929 A1
(43) Pub. Date: Sep. 24, 2026

(54) SPECTACLE LENS COMPRISING RING-SHAPED STRUCTURES AND METHOD

(71) Applicant: Carl Zeiss Vision International GmbH, Aalen (DE)

(72) Inventor: Padmaja Rajagopal Sankaridurg, Sydney (AU)

(73) Assignee: Carl Zeiss Vision International GmbH, Aalen (DE)

(21) Appl. No.: 19/567,119

(22) Filed: Mar. 14, 2026

Related U.S. Application Data
(63) Continuation of application No. PCT/EP2024/081089, filed on Nov. 5, 2024.

(30) Foreign Application Priority Data
Nov. 6, 2023 (EP) 23208022.6

(51) Int. Cl. G02C 7/02; G02C 7/06

(52) U.S. Cl. CPC G02C 7/022; G02C 7/024; G02C 7/066

(57) ABSTRACT

A spectacle lens has a plurality of ring-shaped structures, each ring-shaped structure having a uniform width. One ring-shaped structure or more than one ring-shaped structure of the plurality of ring-shaped structures each have a varying optical power. A variation of a surface mean power of the spectacle lens includes one random component or more random components, the variation being along a ring-shaped path within the one ring-shaped structure or along a ring-shaped path within a same ring-shaped structure of each of the more ring-shaped structures.

### CROSS REFERENCE TO RELATED PATENT APPLICATIONS

This application is a continuation application of international patent application PCT/EP2024/081089, filed on Nov. 5, 2024, and designating the U.S., which claims priority to European patent application EP 23208022.6, filed on Nov. 6, 2023, both of which are hereby incorporated by reference in their entireties.

### FIELD OF THE DISCLOSURE

The disclosure relates to a spectacle lens including a plurality of ring-shaped structures, each ring-shaped structure of the plurality of ring-shaped structures having a uniform width and being limited by two onset lines and to a method for calculating a digital twin of such a spectacle lens.

### BACKGROUND

WO 2024/168652 A1 discloses a spectacle lens comprising a central zone, one ring-shaped structure or more ring-shaped structures each of uniform width. The spectacle lens comprises instead of or additional to the one ring-shaped structure or the more ring-shaped structures one ring-shaped structure or more ring-shaped structures each having a variable surface power. Thus, one ring-shaped structure or more ring-shaped structures is/are having a varying power.

WO 2023/275189 A1 discloses in paragraph [0141] with respect to FIG. 3 that the optical power of optical elements 14 in the left quadrant Q3 and/or the lower quadrant Q4 may be higher than the optical power of the optical elements in the right quadrant Q1 and/or the upper quadrant Q2. The mean optical power of the optical elements in the left quadrant Q3and/or the lower quadrant Q4 may be higher than the mean optical power of the optical elements in the right quadrant Q1 and/or the upper quadrant Q2. WO 2023/275189 A1 discloses in paragraph [0145] that the optical elements 14 may be configured so that along at least one section of the lens element, the mean sphere of the optical elements varies, increases or decreases, from a point of the section towards the peripheral part of the section. Three of the optical elements of FIG. 3 have a varying power.

WO 2021/260642 A1 discloses in paragraph [0155] with respect to FIG. 4B a single geometrically defined shape and/or contour optical element 422, 424, 426 in regions 404, 406, 408 of an ophthalmic lens surface 402. The sagittal power map 400B illustrates that a power profile varies along each individual element. The tangential power map 400C displays that the power of each optical element (e.g., element 426) at the innermost edge 417 and outermost edge 418 are different. Paragraph [0155] further discloses that one region or more regions of the ophthalmic lens may include a plurality of geometrically defined shapes and/or contour optical elements which may be randomly distributed within a region and relative to another region. Paragraph [0163] discloses with respect to FIG. 8, for example, an ophthalmic lens surface comprising a plurality of geometrical defined shapes and/or contour optical elements in a plurality of annular regions. As illustrated in the plan view 800A, the dimensions of the geometrically defined shapes and/or contour optical elements within each region (for example, elements 808a and 808c in region 808) and across regions (for example, elements 804a to 809a in regions 804 to 809) may be of similar shape, length (811) and width (812). Paragraph [0231] discloses with respect to FIG. 29K a spectacle lens having a profile, and a plurality of annular peripheral treatment priority zones 2966 formed by a plurality of geometrically defined shapes and/or contour optical elements with a relatively more positive power than a vision priority zone of +2.5D.

WO 2023/007159 A1 discloses in paragraph [0080] with respect to FIG. 9 a lens having a layer 1100 including a plurality of concentric annular regions 1106a-d, each annular region 1106a-d including a plurality of GRIN optical elements 1102a-d. The GRIN optical elements (one of 1102a-d) are distributed around each annular region 1106a-d such that a positioning of the GRIN optical elements 1102b around one of the annular regions 1106b, is out of phase with the positioning of the GRIN optical elements (1102a and 1102c) in the adjacent annular regions 1106a/1106c.

### Problem to Be Solved

Departing from WO/2024/168652 A1 describing a spectacle lens comprising one ring-shaped structure or more ring-shaped structures each having a variable surface power, the problem to be solved by the disclosure is to provide a spectacle lens intended to minimize an adaptation or a habituation effect for a spectacle lens wearer.

### SUMMARY

The problem has been solved by the spectacle lens including a plurality of ring-shaped structures, each ring-shaped structure of the plurality of ring-shaped structures having a uniform width and being limited by two onset lines and by the computer-implemented method of calculating a digital twin of such a spectacle lens.

The spectacle lens comprises a plurality of ring-shaped structures, each ring-shaped structure of the plurality of ring-shaped structures has a uniform width, each ring-shaped structure of the plurality of ring-shaped structures has a path within a same structure that surrounds a structure-free domain of the same structure from a point within the same structure and ends in the point again, one ring-shaped structure of the plurality of ring-shaped structures or more ring-shaped structures of the plurality of ring-shaped structures each having a varying power, i.e., one ring-shaped structure of the plurality of ring-shaped structures has a varying power or more ring-shaped structures of the plurality of ring-shaped structures have a varying power, the spectacle lens is wherein a variation of a surface mean power comprises one random component or more random components, the variation being along a ring-shaped path within the one ring-shaped structure of the plurality of ring-shaped structures or along a ring-shaped path within a same ring-shaped structure of each of the more ring-shaped structures of the plurality of ring-shaped structures, a random component being a structural feature of:
the one ring-shaped structure and there is no rule to predict a variation of the structural feature along the circumference of the one ring-shaped structure knowing a variation of the structural feature along a part of the circumference of the one ring-shaped structure, or
each of the more ring-shaped structures and there is no rule to predict a variation of the structural feature along the circumference of a same ring-shaped structure of the more ring-shaped structures knowing a variation of the structural feature along a part of the circumference of the same ring-shaped structure of the more ring-shaped structures, or
the more ring-shaped structures and there is no rule to predict a variation of the structural feature along the circumference of a second ring-shaped structure of the more ring-shaped structures knowing a variation of the structural feature along the circumference of a first ring-shaped structure of the more ring-shaped structures.

### BRIEF DESCRIPTION OF THE DRAWINGS

The disclosure will now be described with reference to the drawings wherein:

FIG. 1 shows a spectacle lens having three ring-shaped structures in a plan view;

FIG. 2 shows a spectacle lens having three ring-shaped structures in a plan view; and

FIG. 3 shows a spectacle lens having 16 ring-shaped structures in a plan view.

### DETAILED DESCRIPTION OF EXEMPLARY EMBODIMENTS

A “spectacle lens” is as defined in ISO 13666:2019(E), entry 3.5.2, as an ophthalmic lens (3.5.1) worn in front of, but not in contact with, an eyeball. The spectacle lens typically is a finished spectacle lens, the finished spectacle lens as defined in ISO 13666:2019(E), entry 3.8.7, as spectacle lens (3.5.2) of which both sides have their final optical surface. As in note 1 to entry 3.8.7 of ISO 13666:2019(E), the finished spectacle lens can be either edged (cut) or uncut. The spectacle lens typically is selected from one of the group consisting of
a single-vision spectacle lens as defined in ISO 13666:2019(E), entry 3.7.1
a position-specific single-vision spectacle lens as defined in ISO 13666:2019(E), entry 3.7.2
a power-variation spectacle lens as defined in ISO 13666:2019(E), entry 3.7.7
a progressive-power spectacle lens as defined in ISO 13666:2019(E), entry 3.7.8.

“One ring-shaped structure” of the plurality of ring-shaped structures is, when considered separately from each other ring-shaped structure of the plurality of ring-shaped structures, a ring-shaped domain of the spectacle lens having a surface power different to a surface power of a surface of the spectacle lens comprising the one ring-shaped structure outside the ring-shaped domain occupied by the one ring-shaped structure. In other words, one ring-shaped structure of the plurality of ring-shaped structures is, when considered separately from each other ring-shaped structure of the plurality of ring-shaped structures, the ring-shaped domain of the surface of the spectacle lens having the surface power different to the surface power of the surface of the spectacle lens comprising the one ring-shaped structure outside the ring-shaped domain occupied by the one ring-shaped structure. The surface power of the surface of the spectacle lens is the surface power outside the ring-shaped domain occupied by the one ring-shaped structure and outside any ring-shaped domain occupied by any ring-shaped structure of the plurality of ring-shaped structures. The surface power of the one ring-shaped structure is defined analogously as in ISO 13666:2019(E), entry 3.10.4, as a local ability of a surface of the one ring-shaped structure to change a vergence of a bundle of rays incident at the surface in any position of the surface. As in note 1 to entry 3.10.4 of ISO 13666:2019(E), the surface power of the one ring-shaped structure is determined from a radius or radii of the surface of the one ring-shaped structure and a refractive index (3.1.5) of a material of the one ring-shaped structure, and is calculated for light (3.1.2) incident or emergent in air. The refractive index of the material of the one ring-shaped structure typically is assumed to be a same refractive index as of an optical material of the spectacle lens, the optical material as defined in ISO 13666:2019(E), entry 3.3.1.

With respect to the definitions for the surface power of the surface of the spectacle lens, for structure, and for surface of the spectacle lens, reference is made to the below given definitions. The one ring-shaped structure has a path within the one ring-shaped structure that surrounds a structure-free domain of the one ring-shaped structure from a point within the one ring-shaped structure and ends in the point again. As each ring-shaped structure of the plurality of ring-shaped structures, as described below, the one ring-shaped structure of the plurality of ring-shaped structures is limited by two onset lines, an outer onset line passing along each outer onset of the one ring-shaped structure and an inner onset line passing along each inner onset of the one ring-shaped structure. An outer onset represents, along an outer circumference or along an outer perimeter of the one ring-shaped structure, a first outer position in which a surface of the one ring-shaped structure deviates from the surface of the spectacle lens comprising the one ring-shaped structure. An inner onset represents, along an inner circumference or an inner perimeter, a first inner position in which a surface of the one ring-shaped structure deviates from the surface of the spectacle lens comprising the one ring-shaped structure. In other words, the one ring-shaped structure, when considered separately from each other ring-shaped structure of the plurality of ring-shaped structures, surrounds or encircles a structure-free domain of the surface of the spectacle lens comprising the one ring-shaped structure and the one ring-shaped structure is surrounded or encircled by a structure-free domain of the surface. Typically, the one ring-shaped structure, when considered separately from each other ring-shaped structure of the plurality of ring-shaped structures, surrounds or encircles a structure-free domain of the spectacle lens and, simultaneously, the one ring-shaped structure is surrounded or encircled by a structure-free domain of the spectacle lens. Typically, the surface of the one ring-shaped structure deviates from the surface of the spectacle lens comprising the one ring-shaped structure in that a deviation in surface power increases along any path from the below-defined one common point towards a periphery of the spectacle lens wherein an increase in surface power is discontinuous or an increase in surface power is larger than 3 dioptres over a distance of less than 0.75 mm. A first position of the deviation along the path is the first inner position. Typically, the surface of the one ring-shaped structure deviates from the surface of the spectacle lens comprising the one ring-shaped structure in that the deviation in surface power decreases along any path from the below-defined one common point towards the periphery of the spectacle lens wherein a decrease in surface power is discontinuous or a decrease in surface power is larger than 3 dioptres over a distance of less than 0.75 mm. A first position of the deviation along the path is the first outer position.

A structure-free domain of the one ring-shaped structure, the one ring-shaped structure considered separately from each other ring-shaped structure of the plurality of ring-shaped structures, is a domain of the spectacle lens surface outside the ring-shaped domain of the one ring-shaped structure and outside a respective domain of any ring-shaped structure of the plurality of ring-shaped structures, the structure-free domain of the one ring-shaped structure is encircled or surrounded by the one ring-shaped structure. Typically, the structure-free domain of the one ring-shaped structure is in a vicinity of the one ring-shaped structure, typically separated by the inner onset line of the one ring-shaped structure from the ring-shaped domain of the one ring-shaped structure. The structure-free domain of the one ring-shaped structure, the one ring-shaped structure considered separately from each other ring-shaped structure of the plurality of ring-shaped structures, typically is a domain of the spectacle lens comprising each x, y position of the structure-free domain of the one ring-shaped structure where each x, y position is structure-free in both surfaces of the spectacle lens.

A structure-free domain of the spectacle lens is a domain of the spectacle lens surface i) outside a domain of the one ring-shaped structure of the plurality of ring-shaped structures and ii) outside a respective domain of any ring-shaped structure of the plurality of ring-shaped structures, the structure-free domain of the spectacle lens comprises each x, y position that is structure-free in both surfaces of the spectacle lens.

An x, y position or an x, y, z position typically is defined in an x, y, z coordinate system, the x, y, z coordinate system typically is defined as follows: A predefined point of the spectacle lens defines an origin of the x, y, z coordinate system and i) a surface normal or ii) a primary direction at the predefined point defines a z direction. An x, y direction is in a plane perpendicular to the surface normal or the primary direction. In the plane perpendicular to the surface normal or the primary direction an x direction and a y direction are perpendicular to each other. The predefined point typically is selected from the group consisting of an optical centre of the spectacle lens and a fitting point of the spectacle lens, the optical centre as defined in ISO 13666:2019(E), entry 3.2.15, the fitting point as defined in ISO 13666:2019(E), entry 3.2.34. The primary direction of the spectacle lens is as defined in ISO 13666:2019(E), entry 3.2.25, a direction of a line of sight (3.2.24), usually taken to be a horizontal, to an object at an infinite distance measured with habitual head and body posture when looking straight ahead in unaided vision.

A “plurality of ring-shaped structures” comprises more than one ring-shaped structure. One ring-shaped structure of the plurality of ring-shaped structures is a single ring-shaped structure considered separately from each other structure of the plurality of ring-shaped structures.

More ring-shaped structures of the plurality of ring-shaped structures may include each ring-shaped structure of the plurality of ring-shaped structures. In other words, more ring-shaped structures of the plurality of ring-shaped structures may comprise i) more than one ring-shaped structure of the plurality of ring-shaped structure or ii) each ring-shaped structure of the plurality of ring-shaped structures.

If necessary, a same ring-shaped structure of the plurality of ring-shaped structures needs to be reconstructed between part of the same ring-shaped structure still comprised in an edged spectacle lens, the edged spectacle lens as defined in ISO 13666:2019(E), entry 3.8.9.

A “structure” is a domain of the spectacle lens having a surface power different to a surface power of a surface of the spectacle lens comprising the structure outside the domain occupied by the structure and outside any domain occupied by any structure. The surface power of the structure is defined analogously as in ISO 13666:2019(E), entry 3.10.4, as a local ability of a surface of the structure to change a vergence of a bundle of rays incident at the surface in any position of the surface. As in note 1 to entry 3.10.4 of ISO 13666:2019(E), the surface power of the structure is determined from a radius or radii of the surface of the structure and a refractive index (3.1.5) of a material of the structure, and is calculated for light (3.1.2) incident or emergent in air.

The surface power of the surface of the spectacle lens is defined analogously as in ISO 13666:2019(E), entry 3.10.4, as a local ability of the surface of the spectacle lens to change a vergence of a bundle of rays at the surface in any position of the surface, i.e., as the local ability of a front surface of the spectacle lens to change the vergence of the bundle of rays at the front surface in any position of the front surface or as the local ability of a back surface of the spectacle lens to change the vergence of the bundle of rays at the back surface in any position of the back surface. Analogously as in note 1 to entry 3.10.4 of ISO 13666:2019(E), the surface power of a respective surface of the spectacle lens is determined (i) from a radius or radii of the front surface and a refractive index (3.1.5) of the optical material (3.3.1) of the spectacle lens, and is calculated for light (3.1.2) incident or emergent in air or (ii) from a radius or radii of the back surface and a refractive index (3.1.5) of the optical material (3.3.1) of the spectacle lens, and is calculated for light (3.1.2) incident or emergent in air.

The surface of the spectacle lens typically is either the front surface as defined in ISO 13666:2019(E), entry 3.2.13, or the back surface as defined in ISO 13666:2019(E), entry 3.2.14. At least one of the front surface and the back surface of the spectacle lens may be formed as one of the following surfaces:
a spherical surface as defined in ISO 13666:2019(E), entry 3.4.1,
a cylindrical surface as defined in ISO 13666:2019(E), entry 3.4.2,
an aspherical surface as defined in ISO 13666:2019(E), entry 3.4.3,
a toroidal surface as defined in ISO 13666:2019(E), entry 3.4.6,
an atoroidal surface as defined in ISO 13666:2019(E), entry 3.4.7,
a power-variation surface as defined in ISO 13666:2019(E), entry 3.4.10.

Each structure of a plurality of structures is “ring-shaped” if a same structure of the plurality of structures, the same structure considered separately from each other structure of the plurality of structures, has a path within the same structure that surrounds a structure-free domain of the same structure from a point within the same structure and ends in the point again. In other words, each ring-shaped structure of the plurality of ring-shaped structures, a same ring-shaped structure considered separately from each other ring-shaped structure of the plurality of ring-shaped structures, is a ring-shaped domain of the spectacle lens that has the surface power different to the surface power of the surface of the spectacle lens comprising the same ring-shaped structure outside the ring-shaped domain of the same ring-shaped structure and outside a respective ring-shaped domain of any other ring-shaped structure of the plurality of ring-shaped structures. Thereby, the same ring-shaped structure has a path within the same ring-shaped structure that surrounds a structure-free domain of the same ring-shaped structure from a point within the same ring-shaped structure and ends in the point again. Each ring-shaped structure of the plurality of ring-shaped structures, a same ring-shaped structure considered separately from each other ring-shaped structure of the plurality of ring-shaped structures, may be a circular, an elliptical, an irregular oval, an annular shaped element or any other ring encircling or surrounding the structure-free domain of the same ring-shaped structure, and being encircled or surrounded by a structure-free domain of the spectacle lens. Each ring-shaped structure of the plurality of ring-shaped structures, a same ring-shaped structure considered separately from each other ring-shaped structure of the plurality of ring-shaped structures, may be of a same ring-shape, for example circular. Alternatively, at least one ring-shaped structure of the plurality of ring-shaped structures, again a same ring-shaped structure considered separately from each other ring-shaped structure of the plurality of ring-shaped structures, may be of a different ring-shape, for example elliptical, as other ring-shaped structures of the plurality of ring-shaped structures, for example circular ones. Alternatively, each ring-shaped structure of the plurality of ring-shaped structures, again a same ring-shaped structure considered separately from each other ring-shaped structure of the plurality of ring-shaped structures, may be of a different ring-shape.

Each ring-shaped structure of the plurality of ring-shaped structures, a same ring-shaped structure considered separately from each other ring-shaped structure of the plurality of ring-shaped structures, is limited by two onset lines, an outer onset line passing along each outer onset of the same ring-shaped structure and an inner onset line passing along each inner onset of the same ring-shaped structure. An outer onset represents, along an outer circumference or along an outer perimeter of the same ring-shaped structure, a first outer position in which a surface of the same ring-shaped structure deviates from the surface of the spectacle lens comprising the same ring-shaped structure. An inner onset represents, along an inner circumference or an inner perimeter, a first inner position in which a surface of the same ring-shaped structure deviates from the surface of the spectacle lens comprising the same ring-shaped structure. In other words, again the same ring-shaped structure considered separately from each other ring-shaped structure of the plurality of ring-shaped structures, the same ring-shaped structure surrounds or encircles a structure-free domain of the surface of the spectacle lens comprising the same ring-shaped structure and the same ring-shaped structure is surrounded or encircled by a structure-free domain of the surface. Typically, again the same ring-shaped structure considered separately from each other ring-shaped structure of the plurality of ring-shaped structures, the same ring-shaped structure surrounds or encircles a structure-free domain of the spectacle lens and the same ring-shaped structure is surrounded or encircled by a structure-free domain of the spectacle lens. Typically, the surface of the same ring-shaped structure deviates from the surface of the spectacle lens comprising the same ring-shaped structure in that the deviation in surface power increases along any path from the below-defined one common point towards the periphery of the spectacle lens wherein the increase in surface power is discontinuous or an increase in surface power is larger than 3 dioptres over the distance of less than 0.75 mm.

A first position of the deviation along the path is the first inner position. Typically, the surface of the same ring-shaped structure deviates from the surface of the spectacle lens comprising the same ring-shaped structure in that the deviation in surface power decreases along any path from the below-defined one common point towards the periphery of the spectacle lens wherein the decrease in surface power is discontinuous or the decrease in surface power is larger than 3 dioptres over the distance of less than 0.75 mm. A first position of the deviation along the path is the first outer position.

A “structure-free domain of a same ring-shaped structure” is a domain of the spectacle lens or of the spectacle lens surface outside a respective domain occupied by each ring-shaped structure of the plurality of ring-shaped structures, the respective domain encircled or surrounded by the same ring-shaped structure. The structure-free domain of the same ring-shaped structure is the structure-free domain of the same ring-shaped structure of the spectacle lens when each x, y position of the structure-free domain encircled or surrounded by the same ring-shaped structure is structure-free in both surfaces of the spectacle lens.

A “structure-free domain of the spectacle lens” is a domain of the spectacle lens or of the spectacle lens surface outside a respective domain occupied by each ring-shaped structure of the plurality of ring-shaped structures. Each x, y position of the structure-free domain of the spectacle lens is structure-free in both surfaces of the spectacle lens.

Each ring-shaped structure of the plurality of ring-shaped structures typically encircles or surrounds one common point of the spectacle lens, the common point being either the optical centre or the fitting point of the spectacle lens or any other predetermined point, the optical centre as defined in ISO 13666:2019(E), entry 3.2.15, the fitting point as defined in ISO 13666:2019(E), entry 3.2.34. As in note 1 to entry 3.2.30 of ISO 13666:2019(E), the optical centre (3.2.15) usually applies to the single vision spectacle lens (3.7.1), the fitting point (3.2.34) usually to the position-specific single-vision spectacle lens (3.7.2) or the power-variation spectacle lens (3.7.7). Further, according to ISO 8980-1:2017(E), entry 7.1, position-specific single-vision spectacle lenses shall have permanent alignment reference marking comprising two marks located nominally 34 mm apart, equidistant to a vertical plane through the fitting point. Each ring-shaped structure of the plurality of ring-shaped structures comprises the one common point of the spectacle lens when a same ring-shaped structure encircles or surrounds the common point.

The structure-free domain of an innermost ring-shaped structure of the plurality of ring-shaped structures comprises the common point typically in that the innermost ring-shaped structure has a maximum distance between inner onsets of the innermost ring-shaped structure selected from: a maximum distance of 15 mm, a maximum distance of 12 mm, a maximum distance of 9 mm, a maximum distance of 8 mm, a maximum distance of 7 mm, a maximum distance of 6 mm, a maximum distance of 5 mm. Typically, the structure-free domain of the innermost ring-shaped structure of the plurality of ring-shaped structures is a connected zone or a simply connected zone. The connected is a domain of the spectacle lens and the domain cannot be split up into two or a plurality of independent, not connected zones, typically, the connected zone is the domain on the surface of the spectacle lens, the domain cannot be split up into two or a plurality of independent, not connected zones. The simply connected zone is a domain of the spectacle lens, the domain is path-connected and every path between two points in the domain can be continuously transformed into any other path while preserving two points, typically, the simply connected zone is the domain on the surface of the spectacle lens, the domain on the surface being path-connected and every path between two points in the domain can be continuously transformed into any other path while preserving the two points.

Each ring-shaped structure of the plurality of ring-shaped structures has a surface power different to a surface power of the respective surface of the spectacle lens comprising the plurality of ring-shaped structures outside a respective domain occupied by each ring-shaped structure of the plurality of ring-shaped structures. The surface power of a respective ring-shaped structure of the plurality of ring-shaped structures is defined analogously as in ISO 13666:2019(E), entry 3.10.4, as a local ability of the surface of the respective ring-shaped structure to change a vergence of a bundle of rays incident at the surface in any position of the surface. Analogously as in note 1 to entry 3.10.4 of ISO 13666:2019(E), the surface power of the respective ring-shaped structure is determined from a radius or radii of the surface of the respective ring-shaped structure and a refractive index (3.1.5) of a material of the respective ring-shaped structure, and is calculated for light (3.1.2) incident or emergent in air. The refractive index of the material of each ring-shaped structure typically is assumed to be a same refractive index as of an optical material of the spectacle lens, the optical material as defined in ISO 13666:2019(E), entry 3.3.1.

The surface of a respective ring-shaped structure of the plurality of ring-shaped structures may be selected from one of the following surfaces or may be pieced together from parts selected from one or more of the following parts:
one part or more parts of a spherical surface, the spherical surface as defined in ISO 13666:2019(E), entry 3.4.1
a cylindrical surface as defined in ISO 13666:2019(E), entry 3.4.2
one part or more parts of a cylindrical surface
one part or more parts of an aspherical surface, the aspherical surface as defined in ISO 13666:2019(E), entry 3.4.3
one part or more parts of a toroidal surface, the toroidal surface as defined in ISO 13666:2019(E), entry 3.4.6
one part or more parts of an atoroidal surface, the atoroidal surface as defined in ISO 13666:2019(E), entry 3.4.7
a power-variation surface as defined in ISO 13666:2019(E), entry 3.4.10
one part or more parts of a power-variation surface.

Typically, the surface of the respective ring-shaped structure of the plurality of ring-shaped structures is (i) cylindrical or (ii) with a variation of surface power over part or all of its area, without discontinuity, or pieced together from at least one of (iii) one part or more parts of the cylindrical surface and (iv) one part or more parts of the power-variation surface.

Each surface of a ring-shaped structure of the plurality of ring-shaped structures may have a same surface, typically a respective same surface being selected or pieced together from parts of before mentioned surfaces. Alternatively, one surface of the plurality of ring-shaped structures is different to another surface or other surfaces of the plurality of ring-shaped structures, or more surfaces of the plurality of ring-shaped structures are different to other surfaces of the plurality of ring-shaped structures, typically a respective surface being selected or pieced together from parts of before mentioned surfaces. Alternatively, each surface of the plurality of ring-shaped structures is different, typically a respective surface being selected or pieced together from parts of before mentioned surfaces.

With respect to the surface of the spectacle lens comprising the plurality of ring-shaped structures outside the respective domain occupied by each ring-shaped structure of the plurality of ring-shaped structures, each ring-shaped structure of the plurality of ring-shaped structures may be elevated or depressed, typically elevated. Alternatively, with respect to the surface of the spectacle lens comprising the plurality of ring-shaped structures outside the respective domain occupied by each ring-shaped structure of the plurality of ring-shaped structures, one ring-shaped structure or more ring-shaped structures of the plurality of ring-shaped structures may be elevated while another ring-shaped structure or other ring-shaped structures of the plurality of ring-shaped structures may be depressed. Alternatively, with respect to the surface of the spectacle lens comprising the plurality of ring-shaped structures outside the respective domain occupied by each ring-shaped structure of the plurality of ring-shaped structures, one ring-shaped structure or a same ring-shaped structure of the more ring-shaped structures may be elevated and depressed. In this alternative, another ring-shaped structure or other ring-shaped structures of the plurality of ring-shaped structures may be elevated or depressed with respect to the surface of the spectacle lens comprising the other ring-shaped structure or the other ring-shaped structures outside the respective domain occupied by the other ring-shaped structure(s). Typically, with respect to the surface of the spectacle lens comprising the plurality of ring-shaped structures outside the respective domain occupied by each ring-shaped structure of the plurality of ring-shaped structures, or with respect to the surface of the spectacle lens comprising one ring-shaped structure or more ring-shaped structures of the plurality of ring-shaped structures outside the respective domain occupied by a respective ring-shaped structure, a same ring-shaped structure, the same ring-shaped structure considered separately from each other ring-shaped structure of the plurality of ring-shaped structures, is either elevated or depressed, typically elevated.

A “uniform width” designates a constant distance between onsets of a same ring-shaped structure of the plurality of ring-shaped structures along any direction perpendicular to a circumferential direction of the same ring-shaped structure, the same ring-shaped structure considered separately from each other ring-shaped structure of the plurality of ring-shaped structures. The circumferential direction of a respective same ring-shaped structure of the plurality of ring-shaped structures is defined by a central path between the inner onset line and the outer onset line of the respective same ring-shaped structure. Onsets comprise each inner onset and each outer onset of a respective same ring-shaped structure of the plurality of ring-shaped structures.

Each same ring-shaped structure of the plurality of ring-shaped structures has the constant distance between onsets of each same ring-shaped structure along any direction perpendicular to any circumferential direction of each of the same ring-shaped structures, each of the same ring-shaped structures considered separately from each other ring-shaped structure of the plurality of ring-shaped structures. One ring-shaped structure or more ring-shaped structures of the plurality of ring-shaped structures has/have the uniform width which is constant for the one ring-shaped structure or which is constant for each same ring-shaped structure of the more ring-shaped structures but different to other ring-shaped structures of the plurality of ring-shaped structures. In other words, in the plurality of ring-shaped structures each ring-shaped structure is of uniform width, but the uniform width of different ring-shaped structures may be same or different.

A “surface mean power” is defined analogously as in ISO 13666:2019(E), entry 3.13.12, as focal power (3.10.2) of the surface of one ring-shaped structure of the plurality of ring-shaped structures halfway between two surface-power values in two principal meridians or as focal power (3.10.2) of each surface of more ring-shaped structures of the plurality of ring-shaped structures halfway between two surface power values in two principal meridians. The two surface power values in the two principal meridians are defined as in ISO 13666:2019(E), entry 3.10.4. The two principal meridians in any position of the/each surface are defined analogously as in ISO 13666:2019(E), entry 3.4.5, as meridians with maximum and minimum curvatures in a same position.

A “ring-shaped path within one ring-shaped structure” is a path within the one ring-shaped structure which surrounds the structure-free domain of the same one ring-shaped structure from a point within the same one ring-shaped structure and ends in the point again, the one ring-shaped structure considered separately from each other ring-shaped structure of the plurality of ring-shaped structures. Typically, the ring-shaped path is along a circumferential direction of the one ring-shaped structure. The circumferential direction of the one ring-shaped structure is defined by a central path between the inner onset line and the outer onset line of the one ring-shaped structure.

A “ring-shaped path within a same ring-shaped structure of each of more ring-shaped structures” is a path within the same ring-shaped structure which surrounds the structure-free domain of the same ring-shaped structure from a point within the same ring-shaped structure and ends in the point again, the same ring-shaped structure considered separately from each other structure of the more ring-shaped structures and the plurality of ring-shaped structures. Typically, the ring-shaped path within the same ring-shaped structure of each of the more ring-shaped structures is along a circumferential direction of the same ring-shaped structure. The circumferential direction of the same ring-shaped structure of the more of ring-shaped structures is defined by a central path between the inner onset line and the outer onset line of the same ring-shaped structure.

A “variation in surface mean power” is defined
with respect to one ring-shaped structure as non-uniform surface mean power of the one ring-shaped structure along the ring-shaped path within the same one ring-shaped structure, the one ring-shaped structure considered separately from each other ring-shaped structure of the plurality of ring-shaped structures,
with respect to more ring-shaped structures as non-uniform surface mean power of a same ring-shaped structure of each of the more ring-shaped structures along the ring-shaped path within the same ring-shaped structure, the same ring-shaped structure considered separately from each other structure of the more ring-shaped structures and the plurality of ring-shaped structures.

A “random component” is defined as a structural feature of one ring-shaped structure or of each of more ring-shaped structures that is nondeterministic, i.e., the structural feature is nondeterministic.

A “structural feature” of one ring-shaped structure or of each of more ring-shaped structures is a feature of a respective ring-shaped structure distinguishing the respective ring-shaped structure from the surface comprising the respective ring-shaped structure outside the domain occupied by the respective ring-shaped structure. Alternatively or additionally, the structural feature of the respective ring-shaped structure is a geometrical feature. The structural feature typically is selected from at least one of the group consisting of a dimension such as length along the circumference or a part of the circumference, i.e., the length along the circumference of the part of the circumference where any geometrical feature is distinguishable from other parts of the respective ring-shaped structure, width limited by the onset lines, height along the circumference or a part of the circumference, the surface power along the circumference or a part of the circumference and the surface mean power along the circumference or a part of the circumference.

The structural feature of one ring-shaped structure is “nondeterministic” if there is no rule to predict a variation of the structural feature along the circumference of the one ring-shaped structure knowing a variation of the structural feature along a part of the circumference of the one ring-shaped structure.

The structural feature of each of more ring-shaped structures is “nondeterministic” if there is no rule to predict a variation of the structural feature along the circumference of each same ring-shaped structure knowing a variation of the structural feature along a part of the circumference of each of the same ring-shaped structure. In other words, the structural feature of each of the more ring-shaped structures is nondeterministic if there is no rule to predict the variation of the structural feature along the circumference of a same ring-shaped structure of the more ring-shaped structures knowing a variation of the structural feature along the part of the circumference of the ring-shaped structure of the more ring-shaped structures.

The structural feature of more ring-shaped structures is “nondeterministic” if there is no rule to predict a variation of the structural feature along the circumference of a second ring-shaped structure of the more ring-shaped structures knowing a variation of the structural feature along the circumference of a first ring-shaped structure of the more ring-shaped structures.

The problem has been fully solved by the spectacle lens described before. Due to the random component(s) of the one ring-shaped structure or of each of the more ring-shaped structures, light directed through a portion of the spectacle lens comprising the one ring-shaped structure or each of the more ring-shaped structures provides both in-focus and out-of-focus light at a retina to provide a non-uniform defocus signal at the retina. Since an eye moves independent of the spectacle lens for viewing gazes of the eye, as the eye traverses across the portion of the spectacle lens comprising the one or more ring shaped structure(s), a magnitude of in-focus and out-of-focus light at a retinal plane varies to provide a dynamic and nonuniform blur signal at the retina. Due to the random component(s) of the one ring-shaped structure or of each of the more ring-shaped structures, light directed through the portion of the spectacle lens comprising the one ring-shaped structure or each of the more ring-shaped structures provides both in-focus and out-of-focus light at the retina to provide a non-uniform defocus signal at the retina irrespective of the direction of the gaze of the wearer of the spectacle lens. Due to the random component(s) of the one ring-shaped structure or of each of the more ring-shaped structures light directed through the portion of the spectacle lens comprising the one ring-shaped structure or each of the more ring-shaped structures provides both in-focus and out-of-focus light for a substantial portion of the viewing angles of the eye of the wearer of the spectacle lens. Due to the random component(s) of the one ring-shaped structure or of each of the more ring-shaped structures, light directed through the portion of the spectacle lens comprising the one ring-shaped structure or each of the more ring-shaped structures, provides both in-focus and out-of-focus light for viewing distances from the eye of the wearer of the spectacle lens ranging from infinity to near. Providing simultaneously both in-focus light and out-of-focus light that varies to provide a dynamic and nonuniform blur signal at the retina as explained before is assumed to minimize an adaption or a habituation effect for a spectacle lens wearer.

Typically, the spectacle lens comprises the plurality of ring-shaped structures, each ring-shaped structure having the uniform width, one ring-shaped structure or more ring-shaped structures of the plurality of ring-shaped structures each having the varying power, the spectacle lens is characterized in
the plurality of ring-shaped structures being concentric ring-shaped structures, each of the concentric ring-shaped structures typically comprising the optical centre or the fitting point of the spectacle lens or any other predetermined point on the spectacle lens, or
the more ring-shaped structures being concentric ring-shaped structures, each of the concentric ring-shaped structures typically comprising the optical centre or the fitting point of the spectacle lens or any other predetermined point on the spectacle lens, or
each ring-shaped structure of the plurality of ring-shaped structures comprising the optical centre or the fitting point of the spectacle lens or any other predetermined point on the spectacle lens, or
each ring-shaped structure of the more ring-shaped structures comprising the optical centre or the fitting point of the spectacle lens or any other predetermined point on the spectacle lens.

The more ring-shaped structures being concentric ring-shaped structures typically comprising the optical centre or the fitting point of the spectacle lens typically means that the plurality of ring-shaped structures may comprise, typically additionally to the more concentric ring-shaped structures, a ring-shaped structure or ring-shaped structures that is/are not centered on a same centre as the more concentric ring-shaped structures. The ring-shaped structures that are not centered on the same centre as the more concentric ring-shaped structures may be concentric or non-concentric, typically the ring-shaped structures comprise the optical centre or the fitting point of the spectacle lens. Any ring-shaped structure “comprising” the optical centre or the fitting point or any other predetermined point on the spectacle lens means that any ring-shaped structure is surrounding or encircling the optical centre or the fitting point or any other predetermined point on the spectacle lens.

Each ring-shaped structure of the plurality of ring-shaped structures comprising the optical centre or the fitting point of the spectacle lens typically means that each ring-shaped structure of the plurality of ring-shaped structures is distanced to each neighbouring ring-shaped structure such as to provide the structure-free domain of the spectacle lens adjacent to and along the inner onset line and the outer onset line of a same ring-shaped structure. “Distanced to a/each neighbouring ring-shaped structure” such as to provide the structure-free domain of the spectacle lens adjacent to and along the inner onset line and the outer onset line of a same ring-shaped structure typically means that adjacent to and along the inner onset line of a first ring-shaped structure perpendicular to the circumferential direction of the first ring-shaped structure in any position of the inner onset line a distance to an outer onset line of a second ring-shaped structure, where the inner onset line of the first ring-shaped structure and the outer onset line of the second ring-shaped structure are closest onset lines of two neighbouring ring-shaped structures, is selected from one of the following minimum distances: a minimum distance of 0.2 mm, a minimum distance of 0.3 mm, a minimum distance of 0.4 mm, a minimum distance of 0.5 mm. The minimum distance typically is independent from the uniform widths of the plurality of ring-shaped structures.

The plurality of ring-shaped structures typically are non-concentric ring-shaped structures, each ring-shaped structure of the plurality of ring-shaped structures comprising the optical centre or the fitting point of the spectacle lens. Typically, a centre of each same ring-shaped structure of the plurality of ring-shaped structures is randomly positioned, typically on the surface of the spectacle lens comprising the more ring-shaped structures, such that each ring-shaped structure of the plurality of ring-shaped structures comprises the optical centre or the fitting point of the spectacle lens. A centre of each same ring-shaped structure of the plurality of ring-shaped structures is “randomly positioned” when there is no rule to predict a position of a centre of one ring-shaped structure from a known position of a centre of another ring-shaped structure.

Each ring-shaped structure of the more ring-shaped structures comprising the optical centre or the fitting point of the spectacle lens typically means that the more ring-shaped structures are distanced to each other such as to provide the structure-free domain of the spectacle lens adjacent to and along the inner onset line and the outer onset line of a same ring-shaped structure. The more ring-shaped structures typically are non-concentric ring-shaped structures, each ring-shaped structure of the more ring-shaped structures comprising the optical centre or the fitting point of the spectacle lens. Typically, a centre of each same ring-shaped structure of the more ring-shaped structures is randomly positioned, typically on the surface of the spectacle lens comprising the more ring-shaped structures, such that each ring-shaped structure of the more ring-shaped structures comprises the optical centre or the fitting point of the spectacle lens.

The plurality of ring-shaped structures comprising the more ring-shaped structures, the centre of each ring-shaped structure of the more ring-shaped structures being randomly positioned to comprise the optical centre or the fitting point of the spectacle lens typically means that the plurality of ring-shaped structures may comprise, typically additionally to the before mentioned more ring-shaped structures, a ring-shaped structure or ring-shaped structures whose centre(s) is/are not randomly positioned. Typically, the ring-shaped structure or the ring-shaped structures whose centre(s) is/are not randomly positioned are distanced to the more ring-shaped structures and typically the ring-shaped structures are distanced to each other such as to provide the structure-free domain of the spectacle lens adjacent to and along the inner onset line and the outer onset line of any same ring-shaped structure.

Typically, the spectacle lens comprises the plurality of ring-shaped structures, each ring-shaped structure having the uniform width, one ring-shaped structure or more ring-shaped structures of the plurality of ring-shaped structures each having the varying power, the spectacle lens is wherein the one ring-shaped structure is composed of n segments, n≥2, or each of the more ring-shaped structures each is composed of n segments, n≥2.

A number n of the n segments, n≥2, is selected such that the n segments pieced together result in a same ring-shaped structure. A number n of the n segments, n≥2, is selected such that typically a sum of a length of the n segments is equal to a length of the one ring-shaped structure or a same ring-shaped structure of the more ring-shaped structures. A “length of a same ring-shaped structure” is a length of the same ring-shaped structure determined along its circumferential direction. A “length of a segment” from a start of a segment i, i=1 to n, to an end of the segment i is defined as a length along the circumferential direction of the one ring-shaped structure or a same ring-shaped structure of the more ring-shaped structures. The surface mean power along the circumferential direction of each segment of the n segments is constant, i.e., the variation of the surface mean power is zero, i.e., 0 D, at least along 50% of the length of a same segment. The variation of the surface mean power being “zero” at least along 50% of the length of the same segment typically includes a variation below a threshold of at least one threshold selected from the group consisting of: a threshold of 0.06 D, 0.09 D, 0.12 D. Typically, the variation of the surface mean power is zero at least along the central 50% of the length of a same segment. The start of a segment i+1 is the end of the segment i which in turn is a center point between a point where the surface mean power of the segment i starts to deviate from its constant surface mean power along the circumferential direction and a point where the surface mean power of the segment i+1 begins to stay at its constant surface mean power along the circumferential direction. For i=n, segment n+1 is segment 1.

The start and/or the end of the segment i, i=1 to n, of a same ring-shaped structure of the more ring-shaped structures is not displaced to the start and/or the end of the segment i′, i′=1 to n or i′=1 to n′, of another same ring-shaped structure of the more ring-shaped structures when there is a line from the common point of the more ring-shaped structures through both a) the start of the segment i and the start of the segment i′ and/or b) the end of the segment i and the end of the segment i′.

The start and/or the end of the segment i, i=1 to n, of a same ring-shaped structure of the more ring-shaped structures is displaced to the start and/or the end of the segment i′, i′=1 to n or i′=1 to n′, of another same ring-shaped structure of the more ring-shaped structures when there is no line from the common point of the more ring-shaped structures through both a) the start of the segment i and the start of the segment i′ and/or b) the end of the segment i and the end of the segment i′.

In adjacent segments i, i+1, i=1 to n, of a same ring-shaped structure the surface mean power is different to each other at least along the 50% of the length of each segment of the adjacent segments where the variation of the surface mean power is zero. For i=n, segment n+1 is segment 1.

For example, in case of cylindrical segments having a step between each adjacent cylindrical segments of the n segments of a same ring-shaped structure, the surface mean power within each of the n segments is constant along the circumferential direction and constant along any direction perpendicular to the circumferential direction. Typically, the surface mean power of adjacent cylindrical segments separated by a step is different.

For example, in case of cylindrical segments having a smooth transition between each adjacent cylindrical segments of the n segments of a same ring-shaped structure, the surface mean power within each of the n segments is constant along the circumferential direction and constant along any direction perpendicular to the circumferential direction at least along 50% of the length of the same cylindrical segment.

For example, in case of cylindrical segments having a random transition between each adjacent cylindrical segments of the n segments of a same ring-shaped structure, the surface mean power within each of the n segments is constant along the circumferential direction and constant along any direction perpendicular to the circumferential direction at least along 50% of the length of the same cylindrical segment. A transition between adjacent cylindrical segments is random when there is no rule to predict a transition between adjacent cylindrical segments from a known transition between other adjacent cylindrical segments.

Typically, the length of the segment i, i=1 to n, of a same ring-shaped structure is within a range limited by a predetermined minimal length of the segment i and by the number n and the length of the same ring-shaped structure. The predetermined minimal length of the segment i typically is selected from one of the following lengths: 0.1 mm, 0.2 mm, 0.25 mm, 0.3 mm.

Typically, the length of the segment i, i=1 to n, of a same ring-shaped structure is smaller than at least one of 90%, 80%, 70%, 60%, each of the length of the same ring-shaped structure.

For example, the length of the segment i, i=1 to n, is within one of the following ranges:
the length being within a range of from 0.2 mm to 140 mm,
the length being within a range of from 0.25 mm to 120 mm,
the length being within a range of from 0.3 mm to 100 mm,
the length being within a range of from 0.35 mm to 80 mm.

Typically, the smooth transition or the random transition is 50% or less of the length of the segment.

Typically, the spectacle lens comprises the plurality of ring-shaped structures, each ring-shaped structure having the uniform width, one ring-shaped structure or more ring-shaped structures of the plurality of ring-shaped structures each having the varying power, and the spectacle lens is wherein the one ring-shaped structure is composed of n segments, n≥2, or each of the more ring-shaped structures each is composed of n segments, n≥2, and the one random component being that the number n of the n segments is same or different for each of the more ring-shaped structures.

In case the number n of the n segments is same for each of the more ring-shaped structures, the sum of the length of the n segments is equal to the length of a same ring-shaped structure of the more ring-shaped structures, and typically at least one of the following applies:
the length of at least one segment i, i=1 to n, of the n segments in a same ring-shaped structure of the more ring-shaped structures is different to the length of at least one segment i′, i′=1 to n, i′≠i, of another ring-shaped structure of the more ring-shaped structures, the length of the at least one segment i typically being a random length, i.e., there is no rule to predict the length of the at least one segment i in knowledge of the length of any other segment h, h≠i, of the same ring-shaped structure;
the length of each segment i, i=1 to n, of the n segments in a same ring-shaped structure of the more ring-shaped structures is different to the length of each segment i′, i′=1 to n, i′≠i, of another same ring-shaped structure of the more ring-shaped structures, the length of each segment i typically being a random length, i.e., there is no rule to predict the length of each segment i;
the start of the segment i, i=1 to n, of the n segments in a same ring-shaped structure of the more ring-shaped structures is randomly displaced along the circumferential direction to the start of another segment i′, i′=1 to n, of another same ring-shaped structure of the more ring-shaped structures, and/or the end of the segment i, i=1 to n, of the n segments in a same ring-shaped structure of the more ring-shaped structures is randomly displaced along the circumferential direction to the end of another segment i′, i′=1 to n, of another same ring-shaped structure of the more ring-shaped structures. The start and/or the end of the segment i, i=1 to n, of a same ring-shaped structure of the more ring-shaped structures is randomly displaced to the start and/or the end of the segment i′, i′=1 to n, of another same ring-shaped structure of the more ring-shaped structures when i) there is no line from the common point surrounded or encircled by the more ring-shaped structures towards the periphery of the spectacle lens through both a) the start of the segment i and the start of the segment i′ and/or b) the end of the segment i and the end of the segment i′ and when ii) there is no rule to predict the start of the segment i′ in knowledge of the start of the segment i and/or there is no rule to predict the end of the segment i′ in knowledge of the end of the segment i;
the start of the segment i, i=1 to n, of the n segments in a same ring-shaped structure of the more ring-shaped structures is randomly displaced along the circumferential direction to the start of each other segment i′, i″, i″′, . . . , i′=1 to n, i″=1 to n, i″′=1 to n, . . . , of mutually different ring-shaped structures of the more ring-shaped structures, and/or the end of the segment i, i=1 to n, of the n segments in a same ring-shaped structure of the more ring-shaped structures is randomly displaced along the circumferential direction to the end of each other segment i′, i″, i″′, . . . , i′=1 to n, i″=1 to n, i″′=1 to n, . . . , of mutually different ring-shaped structures of the more ring-shaped structures. The start and/or the end of the segment i, i=1 to n, of a same ring-shaped structure of the more ring-shaped structures is randomly displaced to the start and/or the end of each other segment i′, i″, i″′, . . . , i′=1 to n, i″=1 to n, i″′=1 to n, . . . , of mutually different ring-shaped structures of the more ring-shaped structures when i) there is no line from the common point surrounded or encircled by the more ring-shaped structures towards the periphery of the spectacle lens through both a) the start of the segment i and the start of each segment i′, i″, i″′, . . . and/or b) the end of the segment i and the end of each segment i′ i″, i″′, . . . and when ii) there is no rule to predict the start of each segment i′, i″, i″′, . . . in knowledge of the start of the segment i and/or there is no rule to predict the end of each segment i′, i″, i″′, . . . in knowledge of the end of the segment i;
the surface mean power of at least two segments i₁ and i₂, (i₁, i₂)=1 to n, i₁≠i₂, of the n segments in a same ring-shaped structure of the more ring-shaped structures is different to at least one of
the surface mean power of at least one other segment i₃, i₃=1 to n, i₁≠i₃≠i₂, of the same ring-shaped structure, typically the surface mean power of at least one of the segments i₁, i₂, i₃ is a random surface mean power, i.e., there is no rule to predict the surface mean power of at least one of the segments i₁, i₂, i₃ in knowledge of the surface mean power of any other segment h, h≠i₁, h≠i₂, h≠i₃, of the same ring-shaped structure,
the surface mean power of at least one of segments i₁′ and i₂′, (i₁′, i₂′)=1 to n, i₁′≠i₂′ of the n segments in at least one other same ring-shaped structure of the more ring-shaped structures, typically the surface mean power of at least one of the segments i₁, i₂, i₁′, i₂′ is a random surface mean power, i.e., there is no rule to predict the surface mean power of at least one of the segments i₁, i₂, i₁′, i₂′ in knowledge of the surface mean power of any other segment h of the same ring-shaped structure or in knowledge of the surface mean power of any other segment h′, h′≠i₁, h′≠i₂, h′≠i₁′, h′≠i₂′, of the at least one other same ring-shaped structure,
the surface mean power of at least one of segments i₁′ and i₂′, (i₁′, i₂′)′=1 to n, i₁′≠i₂′, of the n segments in each other same ring-shaped structure of the more ring-shaped structures, typically the surface mean power of at least one of the segments i₁, i₂, i₁′, i₂′ is a random surface mean power, i.e., there is no rule to predict the surface mean power of at least one of the segments i₁, i₂, i₁′, i₂′ in knowledge of the surface mean power of any other segment h of the same ring-shaped structure or in knowledge of the surface mean power of any other segment h′, h′≠i₁, h′≠i₂, h′≠i₁′, h′≠i₂′, of each of the other same ring-shaped structures;
the surface mean power of at least one segment i, i=1 to n, of the n segments in a same ring-shaped structure of the more ring-shaped structures is equal to the surface mean power of at least one segment i′, i′=1 to n, of the n segments of another same ring-shaped structure of the more ring-shaped structures, the start of the at least one segment i being randomly displaced along the circumferential direction to the start of the at least one segment i′ and/or the end of the at least one segment i being randomly displaced along the circumferential direction to the end of the at least one segment i′, randomly displaced with respect to the start and/or the end of segments i and i′ as defined above;
the surface mean power of at least one segment i, i=1 to n, of the n segments in a same ring-shaped structure of the more ring-shaped structures is equal to the surface mean power of at least one segment i′, i″, i″′, . . . , i′=1 to n, i″=1 to n, i″′=1 to n, . . . , of the n segments of each other same ring-shaped structure of the more ring-shaped structures, the start of the at least one segment i being randomly displaced along the circumferential direction to the start of the at least one segment i′, i″, i″′ and/or the end of the at least one segment i being randomly displaced along the circumferential direction to the end of the at least one segment i′, i″, i″′, randomly displaced with respect to the start and/or the end of segments i, i′, i″, i″′ as defined above;
the surface mean power of at least one segment i, i=1 to n, of the n segments in a same ring-shaped structure of the more ring-shaped structures is different to the surface mean power of at least one segment i′, i′=1 to n, of the n segments of another same ring-shaped structure of the more ring-shaped structures, the start of the at least one segment i being randomly displaced along the circumferential direction to the start of the at least one segment i′ and/or the end of the at least one segment i being randomly displaced along the circumferential direction to the end of the at least one segment i′, randomly displaced with respect to the start and/or the end of segment i and i′ as defined above;
the surface mean power of at least one segment i, i=1 to n, of the n segments in a same ring-shaped structure of the more ring-shaped structures is different to the surface mean power of at least one segment i′, i″, i″′, . . . , i′=1 to n, i″=1 to n, i″′=1 to n, . . . , of the n segments of each other same ring-shaped structure of the more ring-shaped structures, the start of the at least one segment i being randomly displaced along the circumferential direction to the start of each of the at least one segments i′, i″, i″′, . . . , and/or the end of the at least one segment i being randomly displaced along the circumferential direction to the end of each of the at least one segments i′, i″, i″′, . . . , randomly displaced with respect to the start and/or the end of segments i, i′, i″, i″′ as defined above.

In case the number n of the n segments is different for each of the more ring-shaped structures, the sum of the length of the n segments is equal to the length of a same ring-shaped structure of the more ring-shaped structures, and typically at least one of the following applies:
the length of each segment i, i=1 to n, of the n segments is equal in one same ring-shaped structure of the more ring-shaped structures and the length is equal to the length of each segment i′, i′=1 to n′, of another same ring-shaped structure, the length typically being a random length. The random length of one segment i, i=1 to n, and predefining the random length being equal for each segment i, i=1 to n, in the same ring-shaped structure and predefining the number n thus determines the circumference of the same ring-shaped structure. When, for example, the one same ring-shaped structure and the other same ring-shaped structure are neighbouring ring-shaped structures both comprising the optical centre or the fitting point of the spectacle lens, i.e., both surrounding the optical centre or the fitting point of the spectacle lens, optionally both having a same centre, the one same ring-shaped structure and the other same ring-shaped structure are distanced to each other by the structure-free domain of the spectacle lens between the outer onset line of the one same ring-shaped structure and the inner onset line of the other same ring-shaped structure, or vice versa, i.e., the inner onset line of the one same ring-shaped structure and the outer onset line of the other same ring-shaped structure, the respective inner and outer onset lines being closest onset lines of neighbouring ring-shaped structures, the respective inner and outer onset lines determined by the length of the respective same ring-shaped structure and the uniform width of the respective same ring-shaped structure. Typically, the length of each segment i is determined such as to have the structure-free zone of the spectacle lens between neighbouring ring-shaped structures;
the length of each segment i, i=1 to n, of the n segments is equal in each same ring-shaped structure of the more ring-shaped structures, the length typically being a random length. Typically, the length of the segments i are determined such as to have the structure-free domain of the spectacle lens between neighbouring ring-shaped structures. The length of the segments i may be determined such that neighbouring ring-shaped structures are distanced to each other equidistantly or not equidistantly;
the surface mean power of one segment i, i=1 to n, is repeated in at least one segment j, j≠i, the segment j not adjacent to segment i, of a same ring-shaped structure of the more ring-shaped structures, the surface mean power of the one segment i typically being a random surface mean power;
the surface mean power of one segment i, i=1 to n, is repeated in at least one segment j, j≠i, the segment j not adjacent to segment i, of a same ring-shaped structure of the more ring-shaped structures, the surface mean power of the one segment i typically being a random surface mean power, the surface mean power of one segment i′, i′=1 to n′, of another same ring-shaped structure is equal to the surface mean power of the one segment i, the surface mean power of the segment i′ is repeated in a segment j′, j′≠i′, the segment j′ not adjacent to segment i′, of the other same ring-shaped structure, the start of the one segment i being randomly displaced to the start of the one segment i′ and/or the end of the one segment i being randomly displaced to the end of the one segment i′. The start and/or the end of the segment i, i=1 to n, of a same ring-shaped structure of the more ring-shaped structures is randomly displaced to the start and/or the end of the segment i′, i′=1 to n′, of another same ring-shaped structure of the more ring-shaped structures when i) there is no line from the common point surrounded or encircled by the more ring-shaped structures towards the periphery of the spectacle lens through both a) the start of the segment i and the start of the segment i′ and/or b) the end of the segment i and the end of the segment i′ and when ii) there is no rule to predict the start of the segment i′ in knowledge of the start of the segment i and/or there is no rule to predict the end of the segment i′ in knowledge of the end of the segment i;
the surface mean power of one segment i, i=1 to n, is repeated in at least one segment j, j≠i, the segment j not adjacent to segment i, of a same ring-shaped structure of the more ring-shaped structures, the surface mean power of the one segment i typically being a random surface mean power, the surface mean power of one segment i′, i″, i″′, . . . , i′=1 to n′, i″=1 to n′, i″′=1 to n′, of each other same ring-shaped structure is equal to the surface mean power of the one segment i, the surface mean power of the segments i′, i″, i″′, . . . , is repeated in a segment j′, j″, j″′, . . . , j′≠i′, the segment j′ not adjacent to segment i′, j″≠i″, the segment j″ not adjacent to segment i″, j″′≠i″′, the segment j″′ not adjacent to segment i″′, and so on, of each of the other same ring-shaped structure, the start of the one segment i being randomly displaced to the start of each of the segments i′, i″, i″′, . . . and/or the end of the one segment i being randomly displaced to the end of each of the segments i′, i″, i″′, . . . . The start and/or the end of the segment i, i=1 to n, of a same ring-shaped structure of the more ring-shaped structures is randomly displaced to the start and/or the end of each other segment i′, i″, i″′, . . . , i′=1 to n′, i″=1 to n′, i″′=1 to n′, . . . , of mutually different ring-shaped structures of the more ring-shaped structures when i) there is no line from the common point surrounded or encircled by the more ring-shaped structures towards the periphery of the spectacle lens through both a) the start of the segment i and the start of each segment i′, i″, i″′, . . . and/or b) the end of the segment i and the end of each segment i′ i″, i″′, . . . and when ii) there is no rule to predict the start of each segment i′, i″, i″′, . . . in knowledge of the start of the segment i and/or there is no rule to predict the end of each segment i′, i″, i″′, . . . in knowledge of the end of the segment i.

The number n of the n segments being same or different for each of the more ring-shaped structures, the sum of the length of the n segments is equal to the length of the same ring-shaped structure of the more ring-shaped structures, typically applies when the plurality of ring-shaped structures comprises the more ring-shaped structures and one of the following applies:
the plurality of ring-shaped structures are concentric ring-shaped structures comprising, i.e., surrounding or encircling, the optical centre or the fitting point of the spectacle lens,
the more ring-shaped structures are concentric ring-shaped structures comprising, i.e., surrounding or encircling, the optical centre or the fitting point of the spectacle lens,
each ring-shaped structure of the plurality of ring-shaped structures comprising, i.e., surrounding or encircling, the optical centre or the fitting point of the spectacle lens,
each ring-shaped structure of the more ring-shaped structures comprising, i.e., surrounding or encircling, the optical centre or the fitting point of the spectacle lens.

Typically, the spectacle lens comprises the plurality of ring-shaped structures, each ring-shaped structure having the uniform width, one ring-shaped structure or more ring-shaped structures of the plurality of ring-shaped structures each having the varying power, the spectacle lens is wherein the one ring-shaped structure is composed of n segments, n≥2, or each of the more ring-shaped structures each is composed of n segments, n≥2, and the one random component being that each of the n segments is having a random surface mean power.

A segment i of the n segments of the one ring-shaped structure, i=1 to n, is having a “random surface mean power” when there is no rule to predict the surface mean power of any other segment j, j≠i, of the one ring-shaped structure in knowledge of the surface mean power of the segment i. Alternatively or additionally, a segment i of the n segments of one ring-shaped structure, i=1 to n, is having a “random surface mean power” when there is no rule to predict the surface mean power of the segment i in knowledge of the surface mean power of any other segment h, h≠i, of the one ring-shaped structure.

Accordingly, a segment i of the n segments of each same ring-shaped structure of the more ring-shaped structures, i=i to n, is having a “random surface mean power” when there is no rule to predict the surface mean power of any other segment j, j≠i, of a same ring-shaped structure in knowledge of the surface mean power of the segment i or when there is no rule to predict the surface mean power of any other segment i′, i″, i″′, . . . , i′=1 to n′, i″=1 to n″, i″′=1 to n″′, of any or each other ring-shaped structure of the more ring-shaped structures in knowledge of the surface mean power of the segment i. Alternatively or additionally, a segment i of the n segments of each same ring-shaped structure of the more ring-shaped structures, i=i to n, is having a “random surface mean power” when there is no rule to predict the surface mean power of the segment i in knowledge of the surface mean power of any other segment h, h≠i, of the same ring-shaped structure or when there is no rule to predict the surface mean power of the segment i in knowledge of the surface mean power of any other segment h′, h″, h″′, . . . , h′≠i, h″≠i, h″′≠i, and so on, of any or each other ring-shaped structure of the more ring-shaped structures.

Typically, a) the random surface mean power of a segment i, i=1 to n, of one ring-shaped structure or b) the random surface mean power of a segment i, i=1 to n, of each same ring-shaped structure of the more ring-shaped structures each is within one of the following ranges:
the random surface mean power is within a range of from 0.2 D to 15 D,
the random surface mean power is within a range of from 0.3 D to 14 D,
the random surface mean power is within a range of from 0.4 D to 13 D,
the random surface mean power is within a range of from 0.5 D to 12 D,
the random surface mean power is within a range of from 1 D to 11 D,
the random surface mean power is within a range of from 1.5 D to 10 D.

The random surface mean power, typically selected from one of the before mentioned ranges, may be in a same range for each segment i, i=1 to n, of at least two ring-shaped structures or each ring-shaped structure of the more ring-shaped structures. The random surface mean power, typically selected from one of the before mentioned ranges, may be in different ranges for each segment i, i=1 to n, of at least two ring-shaped structures or each ring-shaped structure of the more ring-shaped structures.

In case each of the more ring-shaped structures each is composed of n segments, n≥2, n may be same or different for at least two ring-shaped structures of the more ring-shaped structures.

Each of the n segments having a random surface mean power in each of the more ring-shaped structures being composed of n segments, n≥2, the sum of the length of the n segments is equal to the length of the same ring-shaped structure of the more ring-shaped structures, typically applies when the plurality of ring-shaped structures comprises the more ring-shaped structures and one of the following applies:
the plurality of ring-shaped structures are concentric ring-shaped structures comprising, i.e., surrounding or encircling, the optical centre or the fitting point of the spectacle lens,
the more ring-shaped structures are concentric ring-shaped structures comprising, i.e., surrounding or encircling, the optical centre or the fitting point of the spectacle lens,
each ring-shaped structure of the plurality of ring-shaped structures comprising, i.e., surrounding or encircling, the optical centre or the fitting point of the spectacle lens,
each ring-shaped structure of the more ring-shaped structures comprising, i.e., surrounding or encircling, the optical centre or the fitting point of the spectacle lens.

Reference is made to the paragraphs above describing ring-shaped structures with segments of random surface mean power.

Choosing segments of random surface mean power provides simultaneously both in-focus light and out-of-focus light that varies to provide a dynamic and nonuniform blur signal at the retina which is assumed to minimize the adaption or the habituation effect for the spectacle lens wearer. An additional beneficial effect of dividing the one ring-shaped structure or of each of the more ring-shaped structures in segments of random surface mean power is that a manufacturability of the segments along the one ring-shaped structure or along a same ring-shaped structure of the more ring-shaped structure is improved with respect to an arbitrarily random variation of surface mean power along the one ring-shaped structure or along a same ring-shaped structure of the more ring-shaped structure.

Typically, the spectacle lens comprises the plurality of ring-shaped structures, each ring-shaped structure having the uniform width, one ring-shaped structure or more ring-shaped structures of the plurality of ring-shaped structures each having the varying power, the spectacle lens is wherein the one ring-shaped structure is composed of n segments, n≥2, or each of the more ring-shaped structures each is composed of n segments, n≥2, and the one random component being that each of the n segments is of random length.

A segment i of the n segments of the one ring-shaped structure, i=1 to n, is of “random length” when there is no rule to predict the length of any other segment j, j≠i, of the one ring-shaped structure in knowledge of the length of the segment i. Alternatively or additionally, a segment i of n segments of one ring-shaped structure, i=1 to n, is of “random length” when there is no rule to predict the length of the segment i in knowledge of the length of any other segment h, h≠i, of the one ring-shaped structure.

Accordingly, a segment i of the n segments of each same ring-shaped structure of the more ring-shaped structures, i=i to n, is of “random length” when there is no rule to predict the length of any other segment j, j≠i, of a same ring-shaped structure in knowledge of the length of the segment i or when there is no rule to predict the length of any other segment i′, i″, i″′, . . . , i′=1 to n′, i″=1 to n″, i″′=1 to n″′, of any or each other ring-shaped structure of the more ring-shaped structures in knowledge of the length of the segment i. Alternatively or additionally, a segment i of the n segments of each same ring-shaped structure of the more ring-shaped structures, i=i to n, is of “random length” when there is no rule to predict the length of the segment i in knowledge of the length of any other segment h, h≠i, of the same ring-shaped structure or when there is no rule to predict the length of the segment i in knowledge of the length of any other segment h′, h″, h″′, . . . , h′≠i, h″≠i, h″′≠i, and so on, of any or each other ring-shaped structure of the more ring-shaped structures.

In case each of the more ring-shaped structures each is composed of n segments, n≥2, n may be same or different for at least two ring-shaped structures of the more ring-shaped structures.

Each of the n segments being of random length in each of the more ring-shaped structures being composed of n segments, n≥2, the sum of the length of the n segments is equal to the length of the same ring-shaped structure of the more ring-shaped structures, typically applies when the plurality of ring-shaped structures comprises the more ring-shaped structures and one of the following applies:
the plurality of ring-shaped structures are concentric ring-shaped structures comprising, i.e., surrounding or encircling, the optical centre or the fitting point of the spectacle lens,
the more ring-shaped structures are concentric ring-shaped structures comprising, i.e., surrounding or encircling, the optical centre or the fitting point of the spectacle lens,
each ring-shaped structure of the plurality of ring-shaped structures comprising, i.e., surrounding or encircling, the optical centre or the fitting point of the spectacle lens,
each ring-shaped structure of the more ring-shaped structures comprising, i.e., surrounding or encircling, the optical centre or the fitting point of the spectacle lens.

Reference is made to the paragraphs above describing ring-shaped structures with segments of random length.

Choosing segments of random length provides simultaneously both in-focus light and out-of-focus light that varies to provide a dynamic and nonuniform blur signal at the retina which is assumed to minimize the adaption or the habituation effect for the spectacle lens wearer. An additional beneficial effect of dividing the one ring-shaped structure or of each of the more ring-shaped structures in segments of random length is that a manufacturability of the segments along the one ring-shaped structure or along a same ring-shaped structure of the more ring-shaped structure is improved with respect to the arbitrarily random variation of surface mean power along the one ring-shaped structure or along a same ring-shaped structure of the more ring-shaped structure.

Typically, the spectacle lens comprises the plurality of ring-shaped structures, each ring-shaped structure having the uniform width, one ring-shaped structure or more ring-shaped structures of the plurality of ring-shaped structures each having the varying power, the spectacle lens is wherein each of the more ring-shaped structures each is composed of n segments, n≥2, and in that the one random component being at least one of
a) a start of a segment of the n segments of a ring-shaped structure of the more ring-shaped structures is randomly displaced along a circumferential direction to a start of at least one other segment of n′ segments of at least one other ring-shaped structure of the more ring-shaped structures,
b) an end of a segment of the n segments of a ring-shaped structure of the more ring-shaped structures is randomly displaced along a circumferential direction to an end of at least one other segment of n′ segments of at least one other ring-shaped structure of the more ring-shaped structures.

In case each of the more ring-shaped structures each is composed of n segments, n≥2, n may be same or different for at least two ring-shaped structures of the more ring-shaped structures.

The start and/or the end of a segment i, i=1 to n, of a ring-shaped structure being randomly displaced to a segment i′, i′=1 to n or i′=1 to n′, of another ring-shaped structure of the more ring-shaped structures typically applies when the plurality of ring-shaped structures comprises the more ring-shaped structures and one of the following applies:
the plurality of ring-shaped structures are concentric ring-shaped structures comprising, i.e., surrounding or encircling, the optical centre or the fitting point of the spectacle lens,
the more ring-shaped structures are concentric ring-shaped structures comprising, i.e., surrounding or encircling, the optical centre or the fitting point of the spectacle lens,
each ring-shaped structure of the plurality of ring-shaped structures comprising, i.e., surrounding or encircling, the optical centre or the fitting point of the spectacle lens,
each ring-shaped structure of the more ring-shaped structures comprising, i.e., surrounding or encircling, the optical centre or the fitting point of the spectacle lens.

Reference is made to the paragraphs above describing ring-shaped structures with segments whose start and/or end is/are randomly displaced.

Choosing the start or the end of the segment to be randomly displaced, as explained before, provides simultaneously both in-focus light and out-of-focus light that varies to provide a dynamic and nonuniform blur signal at the retina which is assumed to minimize the adaption or the habituation effect for the spectacle lens wearer. An additional beneficial effect of dividing each of the more ring-shaped structures in segments of randomly displaced start or end is that a manufacturability of the segments along a same ring-shaped structure of the more ring-shaped structure is improved with respect to the arbitrarily random variation of surface mean power along a same ring-shaped structure of the more ring-shaped structure.

Typically, the spectacle lens comprises the plurality of ring-shaped structures, each ring-shaped structure having the uniform width, one ring-shaped structure or more ring-shaped structures of the plurality of ring-shaped structures each having the varying power, the spectacle lens is wherein the one ring-shaped structure is composed of n segments, n≥2, or each of the more ring-shaped structures each is composed of n segments, n≥2, and in the one random component being that each transition between adjacent segments of the n segments is a random transition.

A transition between adjacent segments is a “random transition” when there is no rule to predict a transition of any other adjacent segments of the one ring-shaped structure in knowledge of the transition between the adjacent segments. Alternatively or additionally, a transition between adjacent segments is a “random transition” when there is no rule to predict the transition between the adjacent segments in knowledge of a transition between other adjacent segments of one ring-shaped structure.

Accordingly, a transition between adjacent segments of each same ring-shaped structure of the more ring-shaped structures, is a “random transition” when there is no rule to predict the transition of any other adjacent segments of a same ring-shaped structure in knowledge of the transition of the adjacent segments or when there is no rule to predict the transition of any other adjacent segments of any or each other ring-shaped structure of the more ring-shaped structures in knowledge of the transition of the adjacent segments. Alternatively or additionally, a transition between adjacent segments of each same ring-shaped structure of the more ring-shaped structures, is a “random transition” when there is no rule to predict the transition between the adjacent segments in knowledge of a transition between adjacent segments of the same ring-shaped structure or when there is no rule to predict the transition between the adjacent segments in knowledge of a transition between adjacent segments of any or each other ring-shaped structure of the more ring-shaped structures.

The transition between adjacent segments typically is selected from at least one of the group consisting of a step, a sigmoid transition, and any other smooth transition.

In case each of the more ring-shaped structures each is composed of n segments, n≥2, n may be same or different for at least two ring-shaped structures of the more ring-shaped structures.

Each transition between adjacent segments being random typically applies when the plurality of ring-shaped structures comprises the more ring-shaped structures and one of the following applies:
the plurality of ring-shaped structures are concentric ring-shaped structures comprising, i.e., surrounding or encircling, the optical centre or the fitting point of the spectacle lens,
the more ring-shaped structures are concentric ring-shaped structures comprising, i.e., surrounding or encircling, the optical centre or the fitting point of the spectacle lens,
each ring-shaped structure of the plurality of ring-shaped structures comprising, i.e., surrounding or encircling, the optical centre or the fitting point of the spectacle lens,
each ring-shaped structure of the more ring-shaped structures comprising, i.e., surrounding or encircling, the optical centre or the fitting point of the spectacle lens.

Reference is made to the paragraphs above describing transitions.

Choosing a random transition between segments provides simultaneously both in-focus light and out-of-focus light that varies to provide a dynamic and nonuniform blur signal at the retina which is assumed to minimize the adaption or the habituation effect for the spectacle lens wearer.

Typically, the spectacle lens comprises the plurality of ring-shaped structures, each ring-shaped structure having the uniform width, one ring-shaped structure or more ring-shaped structures of the plurality of ring-shaped structures each having the varying power, the spectacle lens is wherein each of the more ring-shaped structures each is composed of n segments, n≥2, and the one random component being that the uniform width is a random uniform width for at least two ring-shaped structures of the more ring-shaped structures.

At least two ring-shaped structures of the more ring-shaped structures are of “random uniform width” when there is no rule to predict the uniform width of at least a second ring-shaped structure in knowledge of the uniform width of at least a first ring-shaped structure of the more ring-shaped structures.

Typically, the uniform width of one ring-shaped structure or of each ring-shaped structure of the more ring-shaped structures is within one of the following ranges selected from:
a range of from 0.1 mm to 8 mm,
a range of from 0.2 mm to 7 mm,
a range of from 0.3 mm to 6 mm,
a range of from 0.4 mm to 5 mm.

In case each of the more ring-shaped structures each is composed of n segments, n≥2, n may be same or different for at least two ring-shaped structures of the more ring-shaped structures.

At least two ring-shaped structures of the more ring-shaped structures having the random uniform width typically applies when the plurality of ring-shaped structures comprises the more ring-shaped structures and one of the following applies:
the plurality of ring-shaped structures are concentric ring-shaped structures comprising, i.e., surrounding or encircling, the optical centre or the fitting point of the spectacle lens,
the more ring-shaped structures are concentric ring-shaped structures comprising, i.e., surrounding or encircling, the optical centre or the fitting point of the spectacle lens,
each ring-shaped structure of the plurality of ring-shaped structures comprising, i.e., surrounding or encircling, the optical centre or the fitting point of the spectacle lens,
each ring-shaped structure of the more ring-shaped structures comprising, i.e., surrounding or encircling, the optical centre or the fitting point of the spectacle lens.

Choosing ring-shaped structures with randomly different uniform width provides simultaneously both in-focus light and out-of-focus light that varies to provide a dynamic and nonuniform blur signal at the retina which is assumed to minimize the adaption or the habituation effect for the spectacle lens wearer.

Typically, the spectacle lens comprises the plurality of ring-shaped structures, each ring-shaped structure having the uniform width, one ring-shaped structure or more ring-shaped structures of the plurality of ring-shaped structures each having the varying power, the spectacle lens is wherein the one ring-shaped structure is composed of n segments, n≥2, or each of the more ring-shaped structures each is composed of n segments, n≥2, and that a number of k different surface mean powers of each of the n segments is repeated along the circumferential direction of a same ring-shaped structure, the number n of the n segments is a multiple of the number k of different surface mean powers, and the one random component is selected from at least one of
the random length of each segment n of a same ring-shaped structure,
the start of a segment of the n segments of a ring-shaped structure of the more ring-shaped structures is randomly displaced along the circumferential direction to the start of at least one other segment of n′ segments of at least one other ring-shaped structure of the more ring-shaped structures,
the end of a segment of the n segments of a ring-shaped structure of the more ring-shaped structures is randomly displaced along a circumferential direction to the end of at least one other segment of n′ segments of at least one other ring-shaped structure of the more ring-shaped structures.

A number of k different surface mean powers of each of the n segments being repeated along the circumferential direction of the same ring-shaped structure, the number n of the n segments being a multiple of the number k of different surface mean powers, typically includes at least one of
a surface mean power k of a segment i, i=1 to n, is repeated in at least a segment j, j≠i, segment j not adjacent to segment i, along the circumferential direction of a same ring-shaped structure,
a surface mean power k of a segment i, i=1 to n, of a ring-shaped structure is repeated in at least a segment i′, i′=1 to n′ of at least one other ring-shaped structure of the more ring-shaped structures,
a surface mean power k of a segment i, i=1 to n, of a ring-shaped structure is repeated in at least a segment i′, i″, i″′, . . . , i′=1 to n′, i″=1 to n″, i″′=1 to n″′, . . . , of each other ring-shaped structure of the more ring-shaped structures,
a sequence of different surface mean powers k, k+1, . . . , of adjacent segments i, i+1, . . . , i=1 to n, is repeated along the circumferential direction of a same ring-shaped structure, for i=n, segment n+1 is segment 1,
a sequence of different surface mean powers k, k+1, . . . of adjacent segments i, i+1, . . . , i=1 to n, is repeated in at least one other ring-shaped structure of the more ring-shaped structures, for i=n, segment n+1 is segment 1,
a sequence of different surface mean powers k, k+1, . . . of adjacent segments i, i+1, . . . , i=1 to n, is repeated in each other ring-shaped structure of the more ring-shaped structures, for i=n, segment n+1 is segment 1.

In case only the sequence of k different surface mean powers of adjacent segments is repeated along the circumferential direction of the same ring-shaped structure, typically the number n of the n segments is dividable by the k different surface mean powers.

For example, in case the number k of different surface mean powers is two, the different surface mean powers are alternating along the circumferential direction of a same ring-shaped structure and the number n of segments i, i=1 to n, of the same ring-shaped structure is even.

Analogously, for example, in case a sequence of m different lengths of adjacent segments is repeated along the circumferential direction of the same ring-shaped structure, typically the number n of the n segments is dividable by the m different length. If, for example, the number m of different lengths is two, the different lengths are alternating along the circumferential direction of a same ring-shaped structure and the number n of segments i, i=1 to n, of the same ring-shaped structure is even.

In case each of the more ring-shaped structures each is composed of n segments, n≥2, n may be same or different for at least two ring-shaped structures of the more ring-shaped structures.

A number of k different surface mean powers of each of the n segments repeated along the circumferential direction of the same ring-shaped structure, the number n of the n segments being the multiple of the number k of different surface mean powers, and the one random component being selected as mentioned before typically applies when the plurality of ring-shaped structures comprises the more ring-shaped structures and one of the following applies:
the plurality of ring-shaped structures are concentric ring-shaped structures comprising the optical centre or the fitting point of the spectacle lens,
the more ring-shaped structures are concentric ring-shaped structures comprising the optical centre or the fitting point of the spectacle lens,
each ring-shaped structure of the plurality of ring-shaped structures comprising the optical centre or the fitting point of the spectacle lens,
each ring-shaped structure of the more ring-shaped structures comprising the optical centre or the fitting point of the spectacle lens.

Choosing the random length of each segment or the start or the end of the segment to be randomly displaced, as explained before, provides simultaneously both in-focus light and out-of-focus light that varies to provide a dynamic and nonuniform blur signal at the retina which is assumed to minimize the adaption or the habituation effect for the spectacle lens wearer. An additional beneficial effect of dividing each of the more ring-shaped structures in segments of repeating surface mean power values is that the nonuniform blur signal at the retina, which is assumed to minimize the adaption or the habituation effect for the spectacle lens wearer, is of comparable effect independent of the viewing direction of the spectacle lens wearer.

The data set comprises at least one kind of the following kinds of data:
(i) a digital representation of the spectacle lens as described before, the digital representation being configured for the purpose of a use for a manufacture of the spectacle lens as described before,
(ii) data containing computer-readable instructions for controlling one or more manufacturing machines in order to produce the spectacle lens as described before.

Alternatively, the data set may comprise the digital representation of the spectacle lens as described before, the digital representation being configured to be fed to one or more manufacturing machines for manufacturing the spectacle lens described before. The data set may be stored on a computer-readable storage medium, carried by a data signal or be in the form of a data signal. The computer-readable storage medium may be a non-transitory tangible computer-readable storage medium.

A “digital representation” of the spectacle lens as described before is a mathematical description of the surface of the spectacle lens comprising and inclusive of the plurality of ring-shaped structures. The mathematical description may be alternatively a piecewise mathematical description for the surface of the spectacle lens comprising the plurality of ring-shaped structures and for each ring-shaped structure of the plurality of ring-shaped structures.

The digital representation of the spectacle lens is configured for the purpose of a use for a manufacture of the spectacle lens as described before.

The digital representation of the spectacle lens is “configured” for the purpose of a use for a manufacture of the spectacle lens when, for example, the digital representation is used for manufacturing a respective casting surface of a mold, the mold being used for casting, i.e., manufacturing, the spectacle lens or for casting a semi-finished spectacle lens blank as defined in ISO 13666:2019(E), entry 3.8.1, that is used for manufacturing the spectacle lens.

The method being configured for calculating by a computer a digital twin of a spectacle lens for the purpose of a use of the digital twin for a manufacture of the spectacle lens, the spectacle lens comprising a plurality of ring-shaped structures, each ring-shaped structure having a uniform width, one ring-shaped structure or more ring-shaped structures of the plurality of ring-shaped structures each having a varying power, the method is characterized in
determining i) one random component or more random components for one structural feature or more structural features of the one ring-shaped structure or ii) one random component or more random components for one structural feature or more structural features of each of the more ring-shaped structures.

In other words, the method configured for calculating by the computer the digital twin of the spectacle lens for the purpose of the use of the digital twin for the manufacture of the spectacle lens, the spectacle lens comprising the plurality of ring-shaped structures, each ring-shaped structure having the uniform width, one ring-shaped structure or more ring-shaped structures of the plurality of ring-shaped structures each having the varying power, the method is characterized in the step of
determining one random component for one structural feature of the one ring-shaped structure, or
determining more random components for one structural feature of the one ring-shaped structure, or
determining one random component for more structural features of each of the more ring-shaped structures, or
determining more random components for more structural features of each of the more ring-shaped structures.

A “digital twin of a spectacle lens” is a mathematical description of a front surface of the spectacle lens, a mathematical description of a back surface of the spectacle lens, and a mathematical description of a refractive index distribution of an optical material of the spectacle lens. The digital twin of the spectacle lens is for the purpose of a use for a manufacture of the spectacle lens. The mathematical descriptions include an orientation of the front surface to the back surface. Therefore, typically, either the front surface and the back surface are described in a same coordinate system or a transformation between a coordinate system of the front surface to a coordinate system of the back surface, or vice versa, is known. The mathematical descriptions typically are closed mathematical descriptions. The mathematical descriptions can be discretized into x, y, z positions, for example, the discrete x, y positions may be defined according to an arbitrarily selected pattern. Typically, the discrete x, y, z positions on or of at least one of the front surface and the back surface are comprised in the digital twin of the spectacle lens.

The one random component typically is determined via a random function, the more random components typically are determined via random functions. The random function(s) typically is/are selected from at least one of the group consisting of a random function for a variation of a surface mean power, a random function for a variation of a uniform width of at least two ring-shaped structures of the more ring-shaped structures, a random function for a variation of a length of a segment i of a ring-shaped structure composed of n segments, i=1 to n, and a random function for a displacement of a segment i of a ring-shaped structure composed of n segments, i=1 to n, with respect to a segment i′ of another ring-shaped structure composed of n′ segments, i′=1 to n′, i≠i′ of at least two mutually different ring-shaped structures of the more ring-shaped structures. In other words, the random function for the displacement of the segment i of the ring-shaped structure composed of n segments, i=1 to n, randomly shifts the start and/or the end of one segment i or more segments i, i=1 to n, with respect to the segment i′ of another ring-shaped structure composed of n′ segments, i′=1 to n′, i≠i′ of the at least two mutually different ring-shaped structures of the more ring-shaped structures.

A “random function for a variation of a surface mean power” is defined as a mathematical function with
i) input value being a position along a ring-shaped path within the one ring-shaped structure or along a ring-shaped path within a same ring-shaped structure of each of the more ring-shaped structures,
ii) output value being the surface mean power at the position, and
iii) a random functional relationship between the input value and the output value.

A “position along a ring-shaped path” is a point at a distance along the ring-shaped path measured from a predefined origin of the ring-shaped path. A “predefined origin” of a ring-shaped path is an intersection point of the ring-shaped path with an arbitrarily selected predefined reference line starting from the common point to the periphery of the spectacle lens. The arbitrarily selected predefined reference line has an intersection point with each ring-shaped path within any ring-shaped structure of the spectacle lens.

A “random functional relationship” between the input value and the output value is a functional relationship that comprises at least one random parameter. A “random parameter” is determined by a predefined probability distribution, for example a normal distribution with a predefined mean and a predefined standard deviation. An example for a random functional relationship is a function f(x−r) where x is the position along the ring-shaped path and r is the random parameter. The function f(x−r) can be a periodic function switching between at least two predefined surface mean power values P₁ and P₂. Another example for a random functional relationship is a periodic function f(x) where x is the position along the ring-shaped path and r is the random parameter switching between at least two random surface mean power values P₁ and P₂ where P₁ is determined by a normal distribution with mean P₁₀ and variance σ₁ and where P₂ is determined by a normal distribution with mean P₂₀ and variance σ₂.

A “random function for a variation of a uniform width” is a predefined probability distribution, for example a normal distribution with a predefined mean and a predefined standard deviation. For example, the uniform width of each ring-shaped structure of the more ring-shaped structures is determined by a normal distribution with mean w₀ and standard deviation σ_{w}.

A “random function for a variation of a length of a segment i of a ring-shaped structure” is a predefined probability distribution, for example a normal distribution with a predefined mean and a predefined standard deviation, defining the length of the segment i. For example, the length of each segment i is determined by a normal distribution with mean l₀ and standard deviation σₗ.

A “random function for a variation of a displacement of a segment i of a ring-shaped structure” is a predefined probability distribution, for example a normal distribution with a predefined mean and a predefined standard deviation, defining the position of the start and/or the end of the segment i along the ring-shaped path within the ring-shaped structure.

Typically, the method configured for calculating by the computer the digital twin of the spectacle lens for the purpose of the use of the digital twin for the manufacture of the spectacle lens, the spectacle lens comprising the plurality of ring-shaped structures, each ring-shaped structure having the uniform width, one ring-shaped structure or more ring-shaped structures of the plurality of ring-shaped structures each having the varying power, the method is characterized in the step of
determining n segments, n≥2, for the one ring-shaped structure or
determining n segments, n≥2, for each ring-shaped structure of the more ring-shaped structures of the plurality of ring-shaped structures.

Typically, the method configured for calculating by the computer the digital twin of the spectacle lens for the purpose of the use of the digital twin for the manufacture of the spectacle lens, the spectacle lens comprising the plurality of ring-shaped structures, each ring-shaped structure having the uniform width, one ring-shaped structure or more ring-shaped structures of the plurality of ring-shaped structures each having the varying power, the method is characterized in the step of
determining the one random component such that a number n of the n segments is same or different for each of the more ring-shaped structures.

Typically, the method configured for calculating by the computer the digital twin of the spectacle lens for the purpose of the use of the digital twin for the manufacture of the spectacle lens, the spectacle lens comprising the plurality of ring-shaped structures, each ring-shaped structure having the uniform width, one ring-shaped structure or more ring-shaped structures of the plurality of ring-shaped structures each having the varying power, the method is characterized in the step of
determining the one random component such that each of the n segments has a random surface mean power.

Typically, the method configured for calculating by the computer the digital twin of the spectacle lens for the purpose of the use of the digital twin for the manufacture of the spectacle lens, the spectacle lens comprising the plurality of ring-shaped structures, each ring-shaped structure having the uniform width, one ring-shaped structure or more ring-shaped structures of the plurality of ring-shaped structures each having the varying power, the method is characterized in the step of
determining the one random component such that each of the n segments is of random length.

Typically, the method configured for calculating by the computer the digital twin of the spectacle lens for the purpose of the use of the digital twin for the manufacture of the spectacle lens, the spectacle lens comprising the plurality of ring-shaped structures, each ring-shaped structure having the uniform width, one ring-shaped structure or more ring-shaped structures of the plurality of ring-shaped structures each having the varying power, the method is characterized in the step
determining the one random component to randomly displace at least one of
a start of a segment of the n segments of a ring-shaped structure of the more ring-shaped structures along a circumferential direction to a start of at least one other segment of n′ segments of at least one other ring-shaped structure of the more ring-shaped structures,
an end of a segment of the n segments of a ring-shaped structure of the more ring-shaped structures along a circumferential direction to an end of at least one other segment of n′ segments of at least one other ring-shaped structure of the more ring-shaped structures.

Typically, the method configured for calculating by the computer the digital twin of the spectacle lens for the purpose of the use of the digital twin for the manufacture of the spectacle lens, the spectacle lens comprising the plurality of ring-shaped structures, each ring-shaped structure having the uniform width, one ring-shaped structure or more ring-shaped structures of the plurality of ring-shaped structures each having the varying power, the method is characterized in the step of
determining the one random component such that each transition between adjacent segments of the n segments is a random transition.

Typically, the method configured for calculating by the computer the digital twin of the spectacle lens for the purpose of the use of the digital twin for the manufacture of the spectacle lens, the spectacle lens comprising the plurality of ring-shaped structures, each ring-shaped structure having the uniform width, one ring-shaped structure or more ring-shaped structures of the plurality of ring-shaped structures each having the varying power, the method is characterized in the step of
determining the one random component such that the uniform width is a random uniform width for at least two ring-shaped structures of the more ring-shaped structures.

Typically, the method configured for calculating by the computer the digital twin of the spectacle lens for the purpose of the use of the digital twin for the manufacture of the spectacle lens, the spectacle lens comprising the plurality of ring-shaped structures, each ring-shaped structure having the uniform width, one ring-shaped structure or more ring-shaped structures of the plurality of ring-shaped structures each having the varying power, the method is characterized in the step of
determining the one random component to be at least one of
the random length of each segment n of a same ring-shaped structure,
to randomly displace the start of a segment of the n segments of a ring-shaped structure of the more ring-shaped structures along the circumferential direction to the start of at least one other segment of n′ segments of at least one other ring-shaped structure of the more ring-shaped structures,
to randomly displace the end of a segment of the n segments of a ring-shaped structure of the more ring-shaped structures along a circumferential direction to the end of at least one other segment of n′ segments of at least one other ring-shaped structure of the more ring-shaped structures,
for that a number of k different surface mean powers of each of the n segments is repeated along the circumferential direction of a same ring-shaped structure, the number n of the n segments is a multiple of the number k of different surface mean powers.

Before given definitions and advantages shall apply for the before described method.

The computer is configured to perform the method described before.

Typically, a data processing system comprising a processor and a storage medium coupled to the processor, wherein the processor is adapted to perform the step: determining i) one random component or more random components for one structural feature or more structural features of the one ring-shaped structure or ii) one random component or more random components for one structural feature or more structural features of each of the more ring-shaped structures based on a computer program stored on a storage medium.

The computer program comprises instructions which, when the program is executed by a computer, cause the computer to carry out the method described before.

Typically, the computer program is stored on a non-transitory tangible computer-readable storage medium, the computer program comprises instructions which, when the program is executed by a computer, cause the computer to carry out the method described before. The computer-readable storage medium having stored thereon the computer program. Typically, the computer-readable storage medium is a non-tangible computer-readable storage medium. The data signal carries the computer program.

The method described before is further configured to manufacture a spectacle lens based on the digital twin of the spectacle lens calculated according to the method. In other words, the method is characterized by the step of manufacturing the spectacle lens based on the digital twin of the spectacle lens calculated by the method described before, i.e., based on the output data of the method described before.

The following clauses describe exemplary embodiments of the disclosure:

Clause 1: Spectacle lens comprising a plurality of ring-shaped structures, each ring-shaped structure having a uniform width, one ring-shaped structure or more ring-shaped structures of the plurality of ring-shaped structures each having a varying power, wherein a variation of a surface mean power comprises one random component or more random components, the variation being along a ring-shaped path within the one ring-shaped structure or along a ring-shaped path within a same ring-shaped structure of each of the more ring-shaped structures.

Clause 2: Spectacle lens according to clause 1, wherein the one ring-shaped structure is composed of n segments, n≥2, or each of the more ring-shaped structures each is composed of n segments, n≥2.

Clause 3: Spectacle lens according to clause 2, wherein the one random component being that a number n of the n segments is same or different for each of the more ring-shaped structures.

Clause 4: Spectacle lens according to any one of the preceding clauses 2 to 3, wherein the one random component being that each of the n segments has a random surface mean power.

Clause 5: Spectacle lens according to any one of the preceding clauses 2 to 4, wherein the one random component being that each of the n segments is of random length.

Clause 6: Spectacle lens according to any one of the preceding clauses 2 to 5, wherein the one random component being selected from at least one of
a) a start of a segment of the n segments of a ring-shaped structure of the more ring-shaped structures is randomly displaced along a circumferential direction to a start of at least one other segment of n′ segments of at least one other ring-shaped structure of the more ring-shaped structures,
b) an end of a segment of the n segments of a ring-shaped structure of the more ring-shaped structures is randomly displaced along a circumferential direction to an end of at least one other segment of n′ segments of at least one other ring-shaped structure of the more ring-shaped structures.

Clause 7: Spectacle lens according to any one of the preceding clauses 2 to 6, wherein the one random component being that each transition between adjacent segments of the n segments is a random transition.

Clause 8: Spectacle lens according to any one of the preceding clauses 2 to 7, wherein the one random component being that the uniform width is a random uniform width for at least two ring-shaped structures of the more ring-shaped structures.

Clause 9: Spectacle lens according to any one of the preceding clauses 2 to 8, wherein a number of k different surface mean powers of each of the n segments is repeated along the circumferential direction of a same ring-shaped structure, the number n of the n segments is a multiple of the number k of different surface mean powers, and the one random component is selected from at least one of
i) the random length of each segment n of a same ring-shaped structure,
ii) the start of a segment of the n segments of a ring-shaped structure of the more ring-shaped structures is randomly displaced along the circumferential direction to the start of at least one other segment of n′ segments of at least one other ring-shaped structure of the more ring-shaped structures,
iii) the end of a segment of the n segments of a ring-shaped structure of the more ring-shaped structures is randomly displaced along a circumferential direction to the end of at least one other segment of n′ segments of at least one other ring-shaped structure of the more ring-shaped structures.

Clause 10: Data set comprising at least one kind of the following kinds of data:
(i) a digital representation of the spectacle lens according to any one of the clauses 1 to 9, the digital representation being for the purpose of a use for a manufacture of the spectacle lens according to any one of the clauses 1 to 9,
(ii) data containing computer-readable instructions for controlling one or more manufacturing machines in order to produce the spectacle lens according to any of the clauses 1 to 9.

Clause 11: Method being configured for calculating by a computer a digital twin of a spectacle lens for the purpose of a use of the digital twin for a manufacture of the spectacle lens, the spectacle lens comprising a plurality of ring-shaped structures, each ring-shaped structure having a uniform width, one ring-shaped structure or more ring-shaped structures of the plurality of ring-shaped structures each having a varying power, the method including
determining i) one random component or more random components for one structural feature or more structural features of the one ring-shaped structure or ii) one random component or more random components for one structural feature or more structural features of each of the more ring-shaped structures.

Clause 12: Computer program comprising instructions which, when the program is executed by a computer, cause the computer to carry out the method of clause 11.

Clause 13: Computer-readable storage medium having stored thereon the computer program of clause 12.

Clause 14: Data signal carrying the computer program of clause 12.

Clause 15: Method according to clause 11 being further configured to manufacture a spectacle lens based on the digital twin of the spectacle lens calculated according to clause 11.

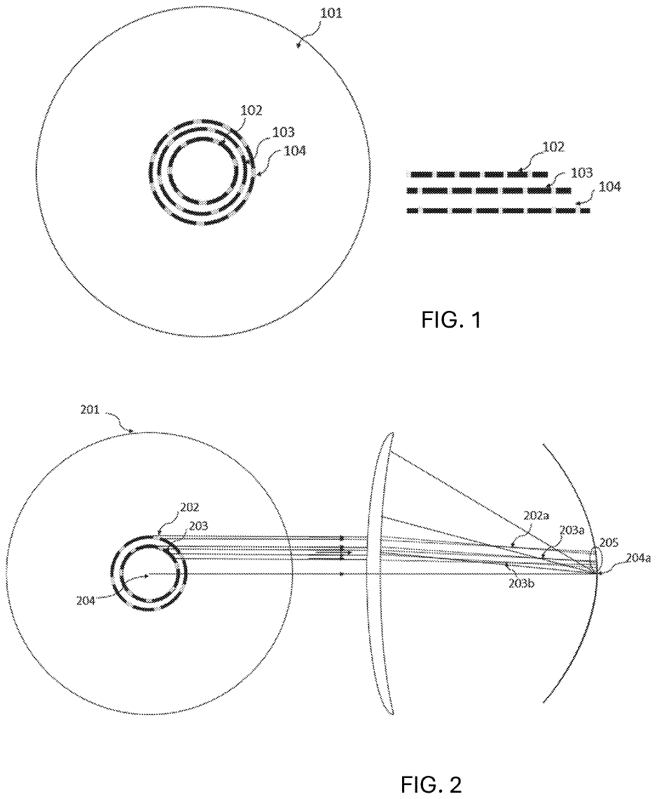

FIG. 1 is a plan view of a spectacle lens 101 comprising three ring-shaped structures 102, 103 and 104 each with a variation in surface mean power along a ring-shaped path within each of the three ring-shaped structures.

In FIG. 1 the structure-free domain of the innermost ring-shaped structure 102 comprises the common point and carries the surface power of the surface of the spectacle lens comprising the three ring-shaped structure. Each of the ring-shaped structures 102, 103, 104 are of uniform width composed of segments (light and dark colored segments). Each of the segments of the ring-shaped structure is of random length, the start and/or the end of each of the segments of the innermost ring-shaped structure is randomly displaced to the start and/or the end of each of the segments of the two other ring-shaped structures and the transition between adjacent segments is random (not shown).

FIG. 2 is a plan view of a spectacle lens 201 comprising two ring-shaped structures 202 and 203 each with a variation in surface mean power along a ring-shaped path within each of the two ring-shaped structures. Each of the ring-shaped structures 202 and 203 are of uniform width and composed of segments with varying surface power.

FIG. 2, side view of the spectacle lens 201, illustrates the path of light passing through the spectacle lens 201 with the two ring-shaped structures 202 and 203 resulting in in-focus and out-of-focus light at the retina. The structure-free domain 204 of the innermost ring-shaped structure 202 has a surface power such that as illustrated light rays passing through focus at the retina 204a of an eye. Light rays passing through the light-colored segment of the ring-shaped structure 202 come to a focus in front of the retina at 202a and continue thereafter to form a blurred region on the retina. Similarly, the light and dark segments of the ring-shaped structure 203 come to a focus in front of the retina at varying distances from the retina 203a and 203b and continue thereafter to form a blurred region on the retina. Light rays passing through the structure-free domains of the spectacle lens form a focus on the retina. Therefore, at the retina 205, light rays are both in focus and out of focus.

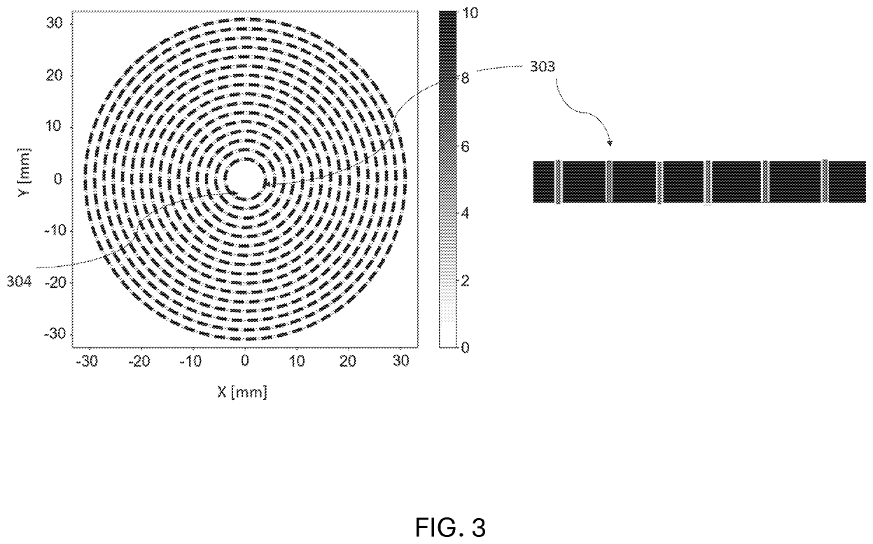

FIG. 3 is a plan view of 16 ring-shaped structures with a variation in surface mean power along a ring-shaped path within each ring-shaped structure for a spectacle lens, the 16 ring-shaped structures are to be placed concentric to the optical centre of the spectacle lens. The structure-free domain 304 of the innermost ring-shaped structure 303 shall comprise the optical centre of the spectacle lens. Each of the 16 ring-shaped structures are of different length and each of the ring-shaped structures are of uniform width. Each of the ring-shaped structure, illustrated in example 303 is comprised of segments that are of random length and have a random surface mean power. The transition between segments is random. The start and/or the end of the light and dark colored segments in neighbouring ring-shaped structures is/are randomly displaced.

The foregoing description of the exemplary embodiments of the disclosure illustrates and describes the present disclosure. Additionally, the disclosure shows and describes only the exemplary embodiments but, as mentioned above, it is to be understood that the disclosure is capable of use in various other combinations, modifications, and environments and is capable of changes or modifications within the scope of the concept as expressed herein, commensurate with the above teachings and/or the skill or knowledge of the relevant art.

The term “comprising” (and its grammatical variations) as used herein is used in the inclusive sense of “having” or “including” and not in the exclusive sense of “consisting only of.” The terms “a” and “the” as used herein are understood to encompass the plural as well as the singular.

All publications, patents and patent applications cited in this specification are herein incorporated by reference, and for any and all purposes, as if each individual publication, patent or patent application were specifically and individually indicated to be incorporated by reference. In the case of inconsistencies, the present disclosure will prevail.

1. A spectacle lens comprising:
a plurality of ring-shaped structures, each ring-shaped structure of the plurality of ring-shaped structures having a uniform width, each ring-shaped structure of the plurality of ring-shaped structures being limited by two onset lines, and each ring-shaped structure of the plurality of ring-shaped structures having a path within a same structure that surrounds a structure-free domain of the same structure from a point within the same structure and ends in the point again,
one ring-shaped structure or more ring-shaped structures of the plurality of ring-shaped structures each having a varying power,
wherein a variation of a surface mean power includes one random component or more random components, the variation being along a ring-shaped path within the one ring-shaped structure of the plurality of ring-shaped structures or along a ring-shaped path within a same ring-shaped structure of each of the more ring-shaped structures of the plurality of ring-shaped structures,
a random component being a structural feature of:
i) the one ring-shaped structure and there is no rule to predict a variation of the structural feature along a circumference of the one ring-shaped structure knowing a variation of the structural feature along a part of the circumference of the one ring-shaped structure; or
ii) each of the more ring-shaped structures and there is no rule to predict the variation of the structural feature along the circumference of a same ring-shaped structure of the more ring-shaped structures knowing a variation of the structural feature along a part of the circumference of the same ring-shaped structure of the more ring-shaped structures; or
iii) the more ring-shaped structures and there is no rule to predict the variation of the structural feature along the circumference of a second ring-shaped structure of the more ring-shaped structures knowing the variation of the structural feature along the circumference of a first ring-shaped structure of the more ring-shaped structures.

2. The spectacle lens according to claim 1, wherein the one ring-shaped structure is composed of n segments, n≥2, or each of the more ring-shaped structures is composed of n segments, n≥2.

3. The spectacle lens according to claim 2, the one random component being that a number n of the n segments is a same or different for each of the more ring-shaped structures.

4. The spectacle lens according to claim 2, the one random component being that each of the n segments has a random surface mean power.

5. The spectacle lens according to claim 2, the one random component being that each of the n segments is of random length.

6. The spectacle lens according to claim 2, the one random component being selected from at least one of:
a) a start of a segment of the n segments of a ring-shaped structure of the more ring-shaped structures is randomly displaced along a circumferential direction to the start of at least one other segment of n′ segments of at least one other ring-shaped structure of the more ring-shaped structures; and
b) an end of a segment of the n segments of a ring-shaped structure of the more ring-shaped structures is randomly displaced along the circumferential direction to an end of at least one other segment of n′ segments of at least one other ring-shaped structure of the more ring-shaped structures.

7. The spectacle lens according to claim 2, the one random component being that each transition between adjacent segments of the n segments is a random transition.

8. The spectacle lens according to claim 2, the one random component being that the uniform width is a random uniform width for at least two ring-shaped structures of the more ring-shaped structures.

9. The spectacle lens according to claim 2, wherein a number of k different surface mean powers of each of the n segments is repeated along the circumferential direction of a same ring-shaped structure, the number n of the n segments is a multiple of the number k of different surface mean powers, and the one random component is selected from at least one of:
i) the random length of each segment n of a same ring-shaped structure;
ii) the start of a segment of the n segments of a ring-shaped structure of the more ring-shaped structures is randomly displaced along the circumferential direction to the start of at least one other segment of n′ segments of at least one other ring-shaped structure of the more ring-shaped structures; and
iii) the end of a segment of the n segments of a ring-shaped structure of the more ring-shaped structures is randomly displaced along a circumferential direction to the end of at least one other segment of n′ segments of at least one other ring-shaped structure of the more ring-shaped structures.

10. A data set comprising at least one kind of the following kinds of data:
(i) a digital representation of the spectacle lens as claimed in claim 1, the digital representation being configured for the purpose of a use for a manufacture of the spectacle lens as claimed in claim 1,
(ii) data containing computer-readable instructions for controlling one or more manufacturing machines in order to produce the spectacle lens as claimed in claim 1.

11. A method for calculating, by a computer, a digital twin of a spectacle lens for the purpose of a use of the digital twin for a manufacture of the spectacle lens, the spectacle lens comprising:
a plurality of ring-shaped structures, each ring-shaped structure having a uniform width, one ring-shaped structure or more ring-shaped structures of the plurality of ring-shaped structures each having a varying power, the method including:
determining i) one random component or more random components for one structural feature or more structural features of the one ring-shaped structure or ii) one random component or more random components for one structural feature or more structural features of each of the more ring-shaped structures.

12. A computer program comprising instructions which, when the program is executed by a computer, cause the computer to carry out the method of claim 11.

13. A computer-readable storage medium having stored thereon the computer program of claim 12.

14. A data signal carrying the computer program of claim 12.

15. The method according to claim 11 being further configured to manufacture a spectacle lens based on the digital twin of the spectacle lens calculated according to claim 11.

16. A computer being configured to perform the method of claim 11.
